(19) United States
(12) Patent Application Publication
(10) Pub. No.: US 2010/0316222 A1
(43) Pub. Date: Dec. 16, 2010

(54) IMAGE PROCESSING SYSTEM

(75) Inventors: Yasuharu Inami, Kahoku-shi (JP); Mutsumu Nagashima, Kahoku-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: PFU LIMITED, Kahoku-shi (JP)

(21) Appl. No.: 12/860,420

(22) Filed: Aug. 20, 2010

Related U.S. Application Data
(63) Continuation of application No. PCT/JP2008/053777, filed on Mar. 3, 2008.

(51) Int. Cl. H04L 9/00

(52) U.S. Cl. 380/277

(57) ABSTRACT

An image processing system 100 decrypting an encrypted image generated by converting a partial area of a bitmap-formatted digital image by using an encryption key includes a key information storage unit 21 stored with a decryption key associated with the encryption key in the way of being associated with a user assigned authority to decrypt a conversion area as an area converted by using the encryption key and to browse the decrypted area, a user authenticating unit 24, a key information acquiring unit 22 acquiring the decryption key associated with the authenticated user in the decryption keys stored in the key information storage unit 21, and a decrypting unit 14 decrypting the conversion area in the encrypted image by using the acquired decryption key to thereby generate the digital image containing the decrypted conversion area of which browsing authority is held by the authenticated user in the conversion areas.

This is a continuation of Application PCT/JP2008/053777, filed on Mar. 3, 2008, now pending, the contents of which are herein wholly incorporated by reference.

### FIELD

The present invention relates to a technology of managing key information used for processing electronic data.

### BACKGROUND

A technology of dealing with encryption of a printed matter is exemplified by a technology of, at first, segmenting a whole image into a plurality of blocks, rearranging images of the segmented blocks based on parameters obtained from an inputted password (encryption key), further black-and-white-inverting and mirror-inverting the images of the blocks designated by the parameters, and thus encrypting the images (refer to Japanese Patent Laid-Open Publication No. H08-179689). On the occasion of decrypting the encrypted image, a positioning frame is attached to the outside of the image, and, after inputting the password (decryption key), the encrypted image is decrypted into the original image through procedures reversed to those for the encryption.

Another technology is that black-and-white squares having a predetermined size, which represent binary data, are arrayed in matrix and embedded into the printed matter (refer to Japanese Patent Publication No. 2938338). Further, for recognizing visualized positions on the occasion of decryption, positioning symbols are attached to predetermined positions of the matrix on the printed matter. Based on these positioning symbols, the image is captured by a scanner and a camera, and the embedded information is decrypted.

Further, there is an information processing device which determines the encryption key corresponding to a confidentiality level of a selected area within data (refer to Japanese Patent Laid-Open Publication No. H05-244150).

### SUMMARY

As described above, there has hitherto been the technology of encrypting the image by processing the image based on the encryption key. Herein, the encryption or decryption of the image entails inputting information about the encryption key or the decryption key, and a user who generates the key information is required to memorize these items of key information. The once-encrypted information needs decrypting after an elapse of time as the case may be. In this case, it is difficult for the user to remember the decryption key memorized when encrypted. Especially when using the key information different on a per-user basis for keeping the confidentiality, key types increase as the number of users rises, resulting in the difficulty of managing the key information.

It is an object of the present invention to provide, in view of the problems described above, an image processing system capable of performing the encryption or the decryption without making a user aware of the key information.

The present invention adopts the following means in order to solve the problems given above. Namely, the present invention is an image processing system generating an encrypted image based on a digital image defined as an aggregation of pixels, including: encryption key storage means stored with an encryption key associated with a decryption key used for decrypting the encrypted image in the way of being associated with a user assigned authority for decrypting a conversion area as an area converted by using the encryption key in the digital image and browsing the decrypted area; authorized user designation accepting means accepting an input of designation of an authorized user authorized to decrypt the conversion area and browse the decrypted area; digital image acquiring means acquiring the encrypting target digital image; encryption key acquiring means acquiring an encryption key associated with the authorized user accepted by the authorized user designation accepting means in the encryption keys stored in the encryption key storage means; and encrypting means converting at least a partial area in the digital image by use of the encryption key acquired by the encryption key acquiring means to thereby generate the encrypted image containing the conversion area that can be decrypted by employing the decryption key associated with the encryption key.

Herein, the digital image is an image defined as the aggregation of pixels of so-called bitmap data etc. The image processing system according to the present invention converts at least the partial area in the digital image by a method such as executing a process of segmenting the digital image on a per-block basis and rearranging the segmented images and performing an adjustment of the pixel information, and generates the encrypted image containing the encrypted conversion area. It should be noted that the encrypted image is also the image defined as the aggregation of pixels.

The conversion (encryption) involves using the encryption key. The conversion is done by employing the encryption key, whereby a proper decryption result can be obtained in the case of using the decryption key associated with this encryption key. An encryption method is exemplified mainly by a symmetric key cryptography (common key cryptography) and an asymmetric key cryptography (public key cryptography), and, in the case employing the symmetric key cryptography, the encryption key is the same as the decryption key.

The image processing system according to the present invention stores the encryption key associated with the decryption key in the way of being associated with the user. Then, the image processing system accepts the designation of the authorized user authorized to browse the target area, and conducts the encryption by employing the encryption key associated with the designated authorized user. With this contrivance being thus made, the user (authorized user) capable of handling the decryption key associated with the encryption key used for the encryption can be authorized to browse pre-converting contents by decrypting the conversion area in the encrypted image while keeping confidentiality of the information through the encryption of the digital image.

An image processing system for decrypting an encrypted image generated by the image processing system described above may be the following image processing system. Namely, an image processing system according to the present invention is an image processing system decrypting an encrypted image generated by converting at least a partial area of a digital image defined as an aggregation of pixels in a way that uses an encryption key, including: decryption key storage means stored with a decryption key associated with the encryption key in the way of being associated with a user assigned authority for decrypting the conversion area as the area converted by use of the encryption key and for browsing the decrypted area; user authenticating means authenticating the user; encrypted image acquiring means acquiring the decrypting target encrypted image; decryption key acquiring means acquiring the decryption key associated with the authenticated user authenticated by the user authenticating means from within the decryption keys stored in the decryption key storage means; and decrypting means decrypting the conversion area in the encrypted image by use of the decryption key acquired by the decryption key acquiring means to thereby generate the digital image containing the decrypted conversion area about which the authenticated user has the decrypting and browsing authority in the conversion areas.

Herein, the user assigned the authority to decrypt the conversion area and to browse the decrypted area is, i.e., a user having the authority to decrypt the conversion area converted by using the predetermined encryption key and to browse the contents in an unencrypted status. The image processing system controls the browsable-by-the-user area in the encrypted image per encryption key used for converting the conversion area by storing the encryption key in the way of being associated with the user.

Moreover, the user authenticating means authenticates the user trying to browse the contents by decrypting the encrypted image. Then, the decryption key acquiring means acquires the encryption key associated with the authenticated user, and the decrypting means performs the decryption by using the acquired decryption key. This operation enables the user to obtain the image with the decrypted area of which the browsing authority is held by the user himself or herself and to browse the decrypted contents only by making the image processing system acquire the encrypted image through authenticating the user.

Namely, according to the present invention, the user can distribute and browse the electronic data and the paper medium each containing the important information without being aware of the key information by designating the authorized user authorized to browse when in encryption and authenticating the user when in decryption. Note that the key information (the encryption key and the decryption key) managed in the image processing system is, it is preferable, managed so as to prevent persons other than a system administrator from knowing the key information.

Further, according to the present invention, the decryption is conducted by using the decryption key associated with the authenticated user while restricting the person having none of the browsing authority from browsing the important information in a way that encrypts the want-to-restrict information, whereby the user having the browsing authority can be authorized to browse the information. In the image processing system according to the present invention, the encrypted information is the image and can be therefore displayed on a display etc and printed on the paper medium for circulation in a state of encrypting only the important information; and further, with respect to even the information which is once printed on the paper medium, the information on the paper medium is read by using a scanner etc and decrypted, thereby enabling the encrypted area to be decrypted.

Still further, the authorized user designation accepting means may accept an input of designation of a plurality of authorized users, the encryption key acquiring means may acquire the encryption key different on a perplural-users basis, and the encrypting means may convert the plurality of areas in the digital image by use of the encryption keys different from each other, thereby generating the encrypted image containing the plurality of conversion areas.

The conversion is carried out by employing the encryption keys different from each other for the plurality of areas in the digital image, whereby the encryption can be conducted by setting every user so as to be authorized or not to be authorized to browse even in a case where the want-to-authorize-or-restrict browsing areas are different on a user-by-user basis.

For decrypting the encrypted image such as this, the encrypted image acquiring means may acquire the encrypted image containing the plurality of conversion area converted by use of encryption keys different from each other, the decryption key acquiring means may acquire the decryption key associated with the authenticated user, and the decrypting means may decrypt the conversion area about which the authenticated user has the decrypting and browsing authority in the plurality of conversion areas contained in the encrypted image by use of the decryption key acquired by the decryption key acquiring means.

This scheme enables the authenticated user to browse the decrypted contents of the area of which the browsing authority is held by the user himself or herself in the plurality of conversion areas converted by using the encryption keys different from each other. It should be noted that with respect to the area of which the browsing authority is not held by the authenticated user, the decryption key is not acquired by the decryption key acquiring means, and hence the user can not browse the decrypted contents of the conversion area of which the authority is not held by the user himself or herself. Namely, according to the present invention, the encryption of the different area involves using the different encryption key, and further only the user having the browsing authority can perform the decryption, whereby access control can be conducted for every area in the digital image.

Yet further, the authority assigned to the user may have a hierarchical relationship, and the decryption key acquiring means may acquire the decryption key associated with the authenticated user and the decryption key associated with the user assigned the lower-level of authority than that of the authenticated user in the decryption keys stored in the decryption key storage means.

Herein, the term “the authority has the hierarchical relationship” connotes that the authority levels have the same high or low hierarchical relationship with each other. The decryption key acquiring means acquires, in addition to the decryption key associated with the authenticated user, the decryption key related to the lower level of authority than that of the authenticated user, thereby enabling the authenticated user to browse the pre-converting contents by decrypting the conversion area in which the user related to the lower level of browsing authority than that of the authenticated user is authorized to browse.

Moreover, the image processing system according to the present invention may further include area designating information acquiring means acquiring area designating information for specifying the conversion area contained in the encrypted image acquired by the encrypted image acquiring means, wherein the decrypting means may decrypt the conversion area specified by the area designating information acquired by the area designating information acquiring means by use of the decryption key acquired by the decryption key acquiring means.

In the encryption according to the present invention, the partial area of the digital image can be designated and thus encrypted. Herein, in the present invention, the encrypting target partial area may be designated by using the area designating information. The area designating information has information for specifying the area on the digital image. The information for specifying the area on the digital image is exemplified such as positional information, size information and vector information.

The image processing system according to the present invention may further include area designating information adding means adding the area designating information for specifying the conversion area converted by the encrypting means to the encrypted image, and the area designating information acquiring means may acquire the area designating information from the information added to the encrypted image.

With this scheme, it is feasible to acquire the added area designating information and execute the accurate decrypting process without causing the user to designate the decryption area on the occasion of the decryption by adding the area designating information for specifying the conversion area to the encrypted image on the occasion of the encryption.

Furthermore, the image processing system according to the present invention may further include area designating information accumulating means accumulated with the area designating information for specifying the conversion area converted by the encrypting means in the way of being associated with the generated encrypted image, and the area designating information acquiring means may acquire the area designating information associated with the encrypted image acquired by the encrypted image acquiring means from the pieces of area designating information accumulated in the area designating information accumulating means.

The area designating information for specifying the conversion area is accumulated on the occasion of the encryption, thereby enabling the user to acquire the accumulated area designating information and execute the accurate decrypting process without causing the user to designate the decryption area on the occasion of the decryption. Further, a specific method of acquiring the area designating information associated with the encrypted image from within the accumulated pieces of area designating information is exemplified by a method of searching through the accumulated pieces of area designating information on the basis of the designated information by making the user designate a type, a name, etc of the encrypted image, a method of searching through the accumulated pieces of area designating information on the basis of the identifying information acquired from the encrypted image by adding the identifying information to the encrypted image, and so on.

The identifying information may be acquired by detecting at least any one of, e.g., a character, a symbol, a pattern and a color contained in the encrypted image from the image. To be more specific, there is a method of acquiring the identifying information from barcodes, a character string, symbols, etc in the image. Moreover, the identifying information may be, in addition to the information obtained by its being detected from the image, information about the encrypted image, i.e., so-called metadata. The area designating information is acquired based on these categories of information, whereby the image processing system can be configured, which automatically selects the optimal area designating information only by designating the encrypted image.

Yet further, the encrypting means, if at least some of the plurality of converting target areas are overlapped, may convert the areas in a predetermined sequence, then the area designating information may, if the encrypted image contains a plurality of conversion areas of which some areas are overlapped, contain information indicating the conversion sequence when in encryption, and the decrypting means may decrypt the conversion area according to the conversion sequence contained in the area designating information acquired by the area designating information acquiring means.

With this scheme, even when the plurality of conversion areas overlaps in the encrypted image, the information on the conversion sequence when in encryption is contained in the area designating information, and the proper decryption result can be obtained by performing the decryption in the sequence (decryption sequence) reversal to the conversion sequence on the occasion of the encryption.

Further, the plurality of areas overlapped with each other is designated as the encrypting target areas when in encryption, and, even in such a case that the overlapped areas are areas in which to set the authorized users (browsing authority levels) different from each other, the decryption can be done in the sequence from the lower order of conversion area in which to set a more relaxed browsing authority level when in decryption by setting the encryption sequence from the higher browsing authority level down to the lower browsing authority level. Moreover, if one of the overlapped areas is completely embraced by the other area, the narrower area (the embraced area) is encrypted earlier, while the broader area (the other area) is decrypted earlier when in decryption, whereby the proper decryption result can be obtained.

Moreover, the image processing system according to present invention may further include electronic data accepting means accepting an input of electronic data, wherein the digital image acquiring means may acquire the digital image by generating the digital image as the aggregation of pixels on the basis of the electronic data.

Herein, the term “electronic data” connotes data containing some category of information such as a document, a graph and an illustration. The electronic data is generated as an electronic file by, e.g., a document creating application, a spreadsheet application, an illustration creating application, etc. The digital image acquiring means generates an image on the occasion of displaying or printing the electronic data as a digital image (e.g., bitmap data) defined as the aggregation of pixels.

With this scheme, the encrypted image based on the electronic data containing the important information can be easily generated, and the data can be thus distributed and circulated without causing the user to perform a time-consuming operation such as converting the electronic data containing the want-to-encrypt information into the digital image.

Further, the present invention can be grasped by way of a method executed by a computer or a program making the computer function as the respective means described above. Moreover, the present invention may also be a recording medium recorded with such a program which can be read by the computer and other devices, machines, etc. Herein, the term “recording medium readable by the computer etc” connotes a recording medium capable of storing information such as data and programs electrically, magnetically, optically, mechanically or by chemical action, which can be read from the computer.

According to the present invention, it is feasible to provide the image processing system capable of performing the encryption or the decryption without making a user aware of the key information.

### BRIEF DESCRIPTION OF THE DRAWINGS

FIG. 1 is a diagram illustrating an outline of a hardware architecture of an image processing system according to an embodiment.

FIG. 2 is a diagram illustrating an outline of a functional configuration of the image processing system according to the embodiment.

FIG. 3 is a diagram illustrating a structure of a key information table according to the embodiment.

FIG. 4 is a diagram illustrating a structure of an area designating information table according to the embodiment.

FIG. 5 is a sequence diagram illustrating a flow of an electronic data encrypting process according to the embodiment.

FIG. 6 is a diagram illustrating a preview screen for a digital image displayed on a display of a user terminal in order to designate an area in the embodiment.

FIG. 7 is a diagram illustrating a display image of the digital image to be encrypted by use of a plurality of encryption keys in the embodiment.

FIG. 8 is a diagram illustrating a display image of the digital image to be encrypted by use of the plurality of encryption keys in the embodiment.

FIG. 9 is a sequence diagram illustrating a flow of an encrypted image decrypting process according to the embodiment.

FIG. 10 is a diagram showing a processing outline (part 1) of the encrypting process and the decrypting process.

FIG. 11 is a diagram showing a processing outline (part 2) of the encrypting process and the decrypting process.

FIG. 12 is a diagram showing an outline of the encrypting process in a first mode.

FIG. 13 is a diagram showing an example of selecting an encryption area.

FIG. 14 is a diagram showing an input example of the encryption key.

FIG. 15 is a diagram showing one example of a scramble process in an image converting unit.

FIG. 16 is a diagram showing another example of the scramble process in the image converting unit.

FIG. 17 is a diagram showing a modified example of a shape of a micro area in the scramble process.

FIG. 18 is a diagram showing a compressing process in the image converting unit.

FIG. 19 is a diagram showing a process of transforming converted image into an image.

FIG. 20 is a diagram showing an example (part 1) of a pixel value converting process in a pixel value converting unit.

FIG. 21 is a diagram showing an example (part 2) of the pixel value converting process in the pixel value converting unit.

FIG. 22 is a diagram showing an example of a positioning marker used for the encrypting process.

FIG. 23 is a diagram showing an example of the encrypted image.

FIG. 24 is a diagram of an example of encrypting a gray-scale image.

FIG. 25 is a diagram showing an outline of a decrypting process in the first mode.

FIG. 26 is a diagram showing a process of detecting the encryption area from the positioning marker.

FIG. 27 is a flowchart showing a flow of an encryption area detecting process.

FIG. 28 is a diagram showing an example in which an encrypted position is detected.

FIG. 29 is a diagram illustrating a whole image in a second mode.

FIG. 30 is a diagram showing and outline of the encrypting process in the second mode.

FIG. 31 is a diagram showing an outline of the decrypting process in the second mode.

FIG. 32 is an explanatory diagram of an encryption area detecting method.

FIG. 33 is an explanatory diagram of a method of detecting an encrypted position (in a horizontal direction).

FIG. 34 is a diagram showing an example of mis-detecting the encrypted position.

FIG. 35 is a diagram showing an outline of the encrypting process in a third mode.

FIG. 36 is a diagram showing an outline of the decrypting process in the third mode.

### DESCRIPTION OF EMBODIMENTS

An embodiment of the present invention will be described with reference to the drawings.

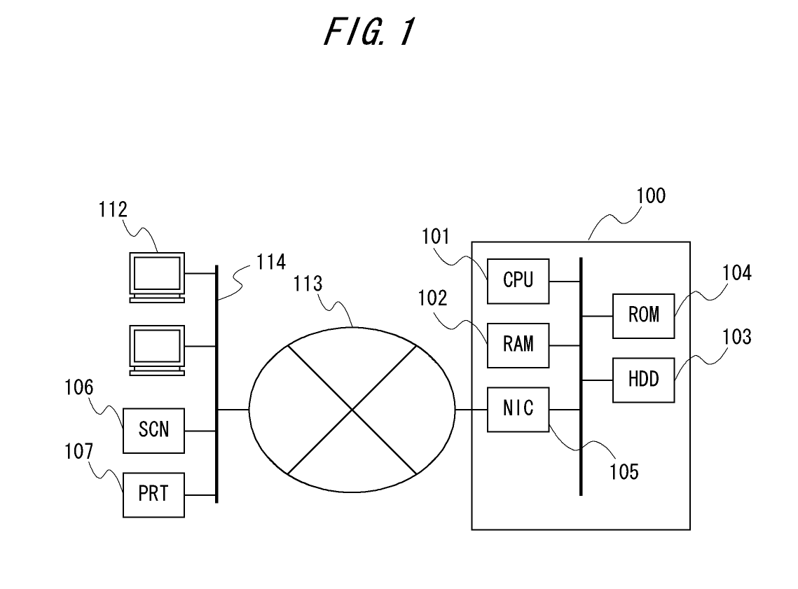

FIG. 1 is a diagram illustrating an outline of a hardware architecture of an image processing system according to the embodiment. Herein, an image processing system 100 is computer including a CPU (Central Processing Unit) 101, a main storage device such as a RAM (Random Access Memory) 102, an auxiliary storage device such as a HDD (Hard Disk Drive) 103, a ROM (Read Only Memory) 104 and a NIC (Network Interface Card) 105, in which a user terminal 112 having a display device such as a display and an input device such as a mouse/keyboard is connected to the NIC 105 via a network 113 such as the Internet and an Intranet. It should be noted that the user terminal 112 is connected to a LAN (Local Area Network) 114, and a scanner 106 and a printer 107 each usable from the user terminal 112 are connected to the LAN 114 in the embodiment.

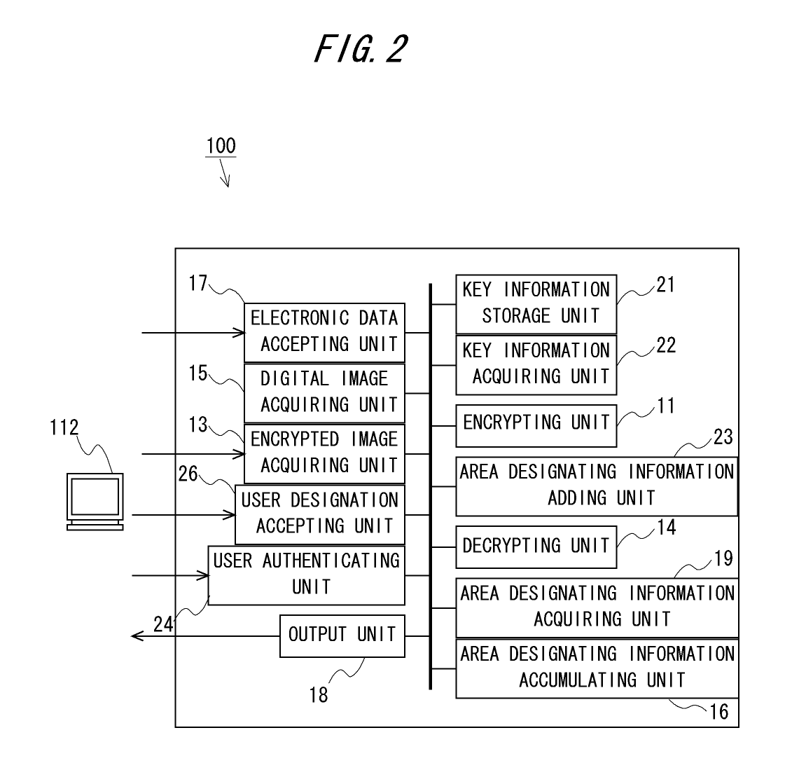

FIG. 2 is a diagram illustrating an outline of a functional configuration of the image processing system 100 according to the embodiment. The computer illustrated in FIG. 1 executes an image processing program read from the HDD 103 and developed on the RAM 102, thereby functioning as the image processing system 100 including an electronic data accepting unit 17 which accepts an input of electronic data transmitted from the user terminal 112, a digital image acquiring unit 15, a user designation accepting unit 26, an output unit 18, a key information storage unit 21, a key information acquiring unit 22, an encrypting unit 11, an area designating information adding unit 23 and an area designating information accumulating unit 16.

Further, the CPU 101 executes, in order to decrypt the encrypted image, the image processing program read from the HDD 103 and developed on the RAM 102, whereby the computer system depicted in FIG. 1 functions as the image processing system 100 further including: an encrypted image acquiring unit 13; a user authenticating unit 24, a decrypting unit 14 and an area designating information acquiring unit 19. Note that the respective function units such as the output unit 18, the key information storage unit 21 and the key information acquiring unit 22 are also used for a process of decrypting the encrypted image.

It should be noted that the embodiment discusses the system according to the present invention as the image processing system 100 including both of the encrypting function and the decrypting function, however, the image processing system 100 according to the present invention may also be embodied as an encryption system including the encrypting function or a decryption system including the decrypting function.

The digital image acquiring unit 15 acquires an encrypting target digital image by directly acquiring the digital image transmitted from the user terminal 112 or generating the digital image on the basis of the digital data accepted by the electronic data accepting unit 17. Herein, the electronic data is electronic data (electronic document) dealt with by applications such as a document creating application and a spreadsheet application. The digital image acquiring unit 15 converts an image, in the case of generating the digital image based on the electronic data or printing the electronic data on a paper medium or displaying the electronic data on a display, into the digital image in a so-called bitmap format. Normally, the electronic data related to, e.g., a document, the data includes character codes and format information, however, the image of displaying or printing the electronic data, is generated as the image in the bitmap format, whereby the encrypting unit 11 can encrypt the image.

The image processing system 100 according to the embodiment generates the encrypted image by converting at least a partial area of the digital image on the basis of an encryption key and further decrypts the converted area in the encrypted image on the basis of a decryption key. Herein, the area converted by use of the encryption key in the encrypted image is referred to as a conversion area. Note that a plurality of conversion areas in the single image can be specified, and the conversion area contains setting of an authorized user authorized to browse a content of a decrypted status by decrypting the conversion area. The user designation accepting unit 26 accepts an input of designation of the authorized user authorized to browse in a way that decrypts the conversion area designated by the user.

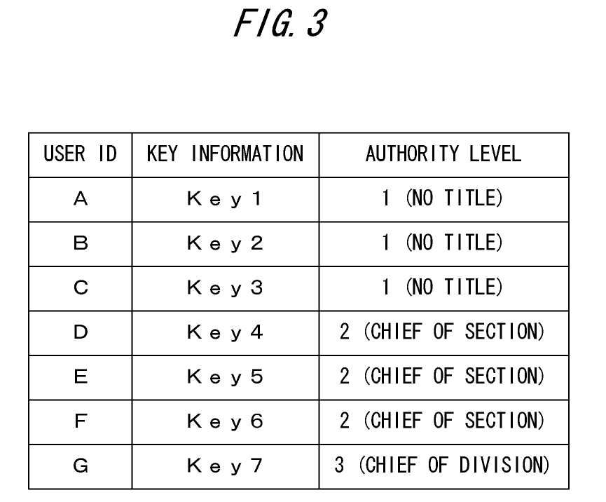

The key information storage unit 21 is stored with the encryption key and the decryption key in a way that associates these keys with each other. It should be noted that the encryption method according to the embodiment is the symmetric key cryptography, and hence the encryption key and the decryption key are the same. FIG. 3 is a diagram illustrating a structure of a key information table according to the embodiment. The key information table is accumulated with an authority level, a user ID and key information in the way of being associated with each other. Herein, the user ID is information which is uniquely allocated to the user of the system and used for identifying the user, while the key information is information used on the occasion of encrypting or decrypting the area in which the user is set as the authorized user.

Further, the authority level is information for setting the authority for browsing respective items of information contained in the electronic data and the digital image, and a scheme in the embodiment is that a larger numeric value indicated by the authority level has a higher level of browsing authority. For example, in the case of utilizing the image processing system 100 according to the embodiment in an enterprise, as illustrated in FIG. 3, the authority levels are set in such a way that an authority level 1 is assigned to an employee with no title, an authority level 2 is assigned to a chief of the section, and an authority level 3 is assigned to a chief of the division. Herein, the user assigned the high level of browsing authority has the authority for browsing the areas browsable by users assigned the lower level of authority than the browsing authority level of the former user himself or herself. Specifically, the users F and G assigned the authority level 3 can browse the contents of the conversion areas in which any users ranging from a user A to a user E are set as the authorized users by decrypting these conversion areas as well as browsing the conversion areas in which the users themselves (the user F and G) are set as the authorized users when in the encryption. By contrast, the users D, E assigned the authority level 2 can browse the content of the conversion area in which any one of the users A through C is set but can not browse the content of the conversion area in which the user F or G is set as the authorized user.

Note that at least the key information in the items of information accumulated in the key information table is encrypted, and only a system administrator is authorized to browse the information in plaintext. This contrivance enables the image processing system 100 to be configured, which is capable of performing the access control without causing the user to take a time-consuming operation for managing the key information, and also can prevent the user from acquiring the key information of other users and encrypting or decrypting the information in an unauthorized manner.

The key information acquiring unit 22 searches the key information table with the user ID being used as a search key, thereby acquiring the key information associated with the user specified by the user ID. To be specific, the key information acquiring unit 22 searches the key information table by use of the user ID of the authorized user accepted by the user designation accepting unit 26 when in the encrypting process, thereby acquiring the encryption key used for encrypting the area in which the authorized user is set. Further, the key information acquiring unit 22 searches the key information table by use of the user ID of the authenticated user authenticated by the user authenticating unit 24 when in the decrypting process, thereby acquiring the decryption key usable by the authenticated user. Note that the key information acquiring unit 22 further acquires, in addition to the decryption key associated with the authenticated user, the decryption keys associated with other users assigned the lower level of authority than that of the authenticated user in the decryption keys accumulated in the key information table.

The encrypting unit 11 converts at least the partial area (encryption area) in the digital image by employing the encryption key acquired by the key information acquiring unit 22, thereby generating an encrypted image containing the conversion area that can be decrypted by use of the decryption key corresponding to this encryption key. Further, the encrypting unit 11, when the plurality of encrypting target encryption areas is designated in the digital image and if the authorized user is different on a per-area basis, performs the encryption by using the encryption key different per area. Moreover, the encrypting unit 11, if at least a part of the plurality of conversion target areas overlaps, determines an encryption sequence according to a predetermined rule, and conducts the conversion in this sequence. Note that an in-depth description of the encrypting process of the encrypting unit 11 will be hereinafter be made.

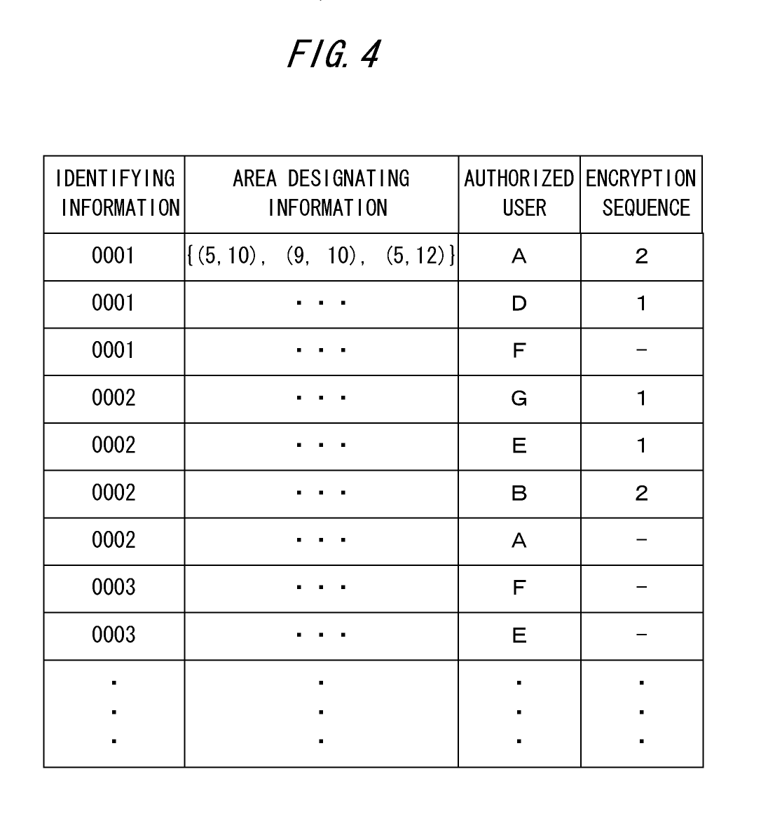

The area designating information adding unit 23 adds the area designating information for specifying the conversion area converted by the encrypting unit 11 to the generated encrypted image together with the user ID of the user designated as the authorized user of the conversion area. Herein, the term “area designating information” connotes information containing positional information etc for designating the conversion area in the digital image. The information used for designating the conversion area is exemplified by positional information indicating a position in the digital image, size information, vector information, etc. The conversion area is designated by employing any one or more of these items of information. For instance, the encrypting process, which will be described later on, involves using 3-point positional information for designating a rectangular conversion area. The positional information can be expressed generally based on an x-axis and a y-axis orthogonal to the x-axis by use of units such as centimeters, inches and pixels (see FIG. 4). Further, positions from the edge of the digital image on the x-axis and the y-axis may be indicated by a percentage (%), in which a width or a length of the digital image is used as the unit. Another thinkable method is that the numbers are allocated to all the pixels of the digital image (e.g., the consecutive numbers are allocated to the pixels from the left upper pixel down to the right lower pixel) to thereby specify the position by employing this number).

Moreover, the position designated as the conversion area by the area designating information corresponds to a position in which to record the encrypting target information in the electronic data becoming a basis for generating the digital image. For example, if individual information such as a Social Security Number (SSN) and an e-mail address is encrypting target important information in the electronic data about the document, an area in which to dispose these items of information in the generated digital image is designated by the area designating information.

The area designating information accumulating unit 16 accumulates, in the area designating information table, the area designating information for specifying the conversion area defined as the encryption area in the way of being associated with the user ID of the user designated as the authorized user of the conversion area and the encrypted image containing this conversion area.

FIG. 4 is a diagram illustrating a structure of the area designating information table in the embodiment. The area designating information table is recorded with the area designating information containing the positional information for indicating the area in the digital image and the user ID of the authorized user in the way of being associated with a unique piece of identifying information which specifies the encrypted image. Further, the area designating information table further includes, if the encrypted images have the conversion areas overlapping with each other, an encryption sequence of the encrypting unit 11.

The encrypted image acquiring unit 13 acquires the encrypted image designated by the user's operation. Note that the encrypted image acquired by the encrypted image acquiring unit 13 may be the image which is output temporarily onto the paper medium after being encrypted and is obtained from the information on the paper medium as the encrypted image by capturing the image of the paper medium in a way that employs a device such as a scanner 106 and a digital camera capable of capturing the image of the paper medium.

The area designating information acquiring unit 19 acquires the area designating information for specifying the conversion area contained in the encrypted image acquired by the encrypted image acquiring unit 13. Herein, the area designating information acquiring unit 19 may acquire the area designating information from the information added to the encrypted image by the area designating information adding unit 23 and may also acquire the area designating information associated with the encrypted image from the pieces of area designating information accumulated by the area designating information accumulating unit 16.

The decrypting unit 14 decrypts the conversion area in the encrypted image acquired by the encrypted image acquiring unit 13 by use of the decryption key acquired by the key information acquiring unit 22, thereby generating the digital image in which to decrypt the conversion area having the decrypted content about which the authenticated user has the browsing authority in the conversion area specified by the area designating information acquired by the area designating information acquiring unit 19. Further, the decrypting unit 14, if at least a part of the plurality of decrypting target areas overlaps, decrypts the conversion areas in the sequence reversal to the encryption sequence contained in the area designating information. Incidentally, an in-depth description of the decrypting process by the decrypting unit 14 will be made later on.

The output unit 18 transmits, to the user terminal 112, the encrypted image generated by the encrypting unit 11 or the digital image decrypted by the decrypting unit 14. An output destination of the generated encrypted image may be a storage device such as the HDD 103, the display device such as a monitor, and the printer 107.

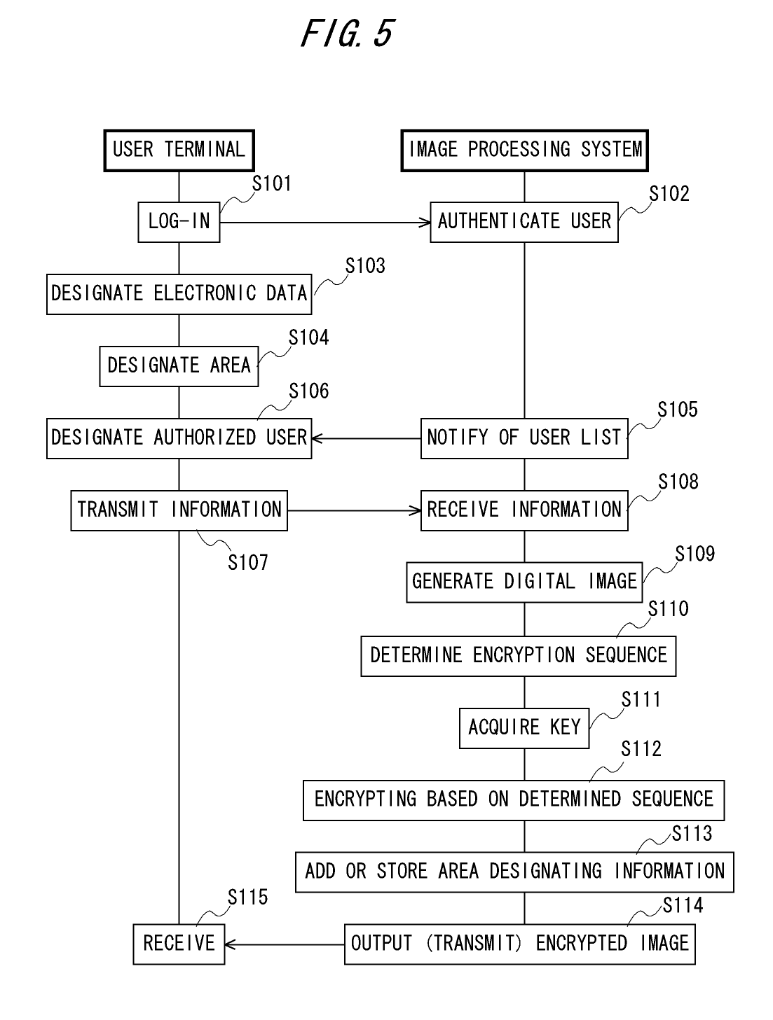

FIG. 5 is a sequence diagram illustrating a flow of an electronic data encrypting process according to the embodiment. The electronic data encrypting process is started by an event that the user logs in the image processing system 100 by operating the user terminal 112 employed for transmitting the want-to-encrypt electronic data.

In steps S101 and S102, a log-in process is executed. The user terminal 112, upon receiving an input of a log-in instruction from the user, transmits log-in information to the image processing system 100 (step S101). This log-in information contains a password etc in addition to the information for identifying the user who operates the terminal. The image processing system 100 receives the log-in information, and the user authenticating unit 24 authenticates the user by comparing the received log-in information with information for the authentication that is retained on the server side (step S102). Note that the log-in process may involve performing the communications plural number of times between the user terminal 112 and the image processing system 100. Furthermore, an available scheme is that an authentication server for authenticating the user terminal 112 is prepared separately from the image processing system 100, whereby the user is authenticated. Thereafter, the processing advances to step S103.

In steps S103 and S104, the encrypting target electronic data is designated, and the encryption area within the electronic data is designated. The user terminal 112 determines, based on the user's operation, the want-to-encrypt electronic data from the electronic data retained on the user terminal 112 or the electronic data inputted from the outside by employing the scanner 106 etc (step S103), and further designates the area within the encrypting target electronic data in the image processing system 100 (step S104). Note that the electronic data designated herein may be the digital image in the bitmap format such as JPEG (Joint Photographic Experts Group), GIF (Graphics Interchange Format) and TIFF (Tagged Image File Format). This case does not entail a digital image generating process given in step S109, which will hereinafter be described.

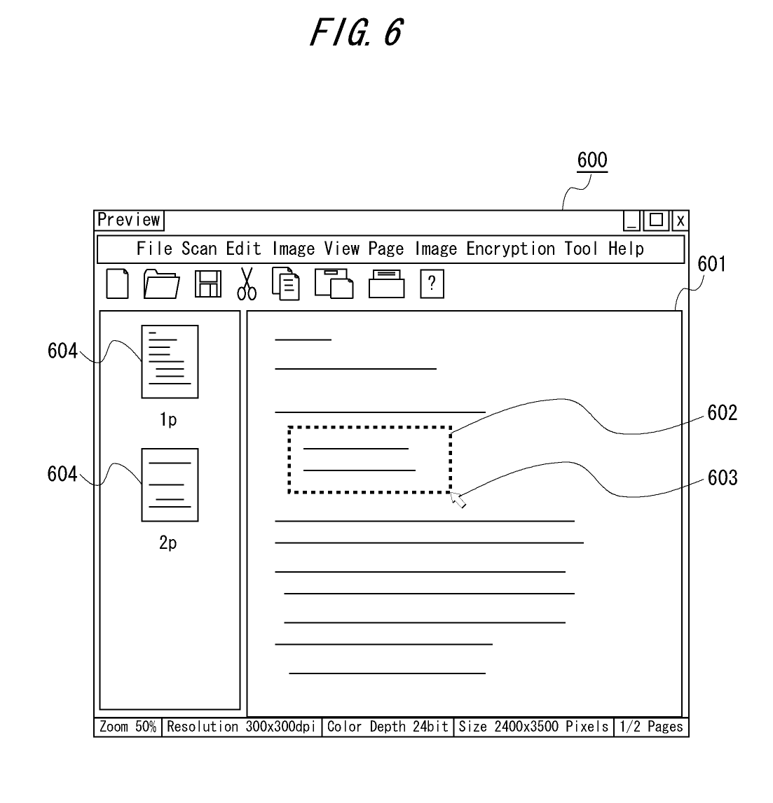

FIG. 6 is a diagram illustrating a preview screen 600 of the digital image displayed on the display of the user terminal 112 in order to designate the area in the embodiment. A digital image 601 used for the definition of the definition information is displayed on the preview screen 600, and the user terminal 112 accepts the designation of the encrypting target area through a range designating operation using an input device such as a mouse. In the embodiment, a main button of the mouse is kept pressing in a position where a left upper vertex of an encrypting target rectangular area 602 on the digital image 601 displayed on the display is desired to be formed, then a pointer 603 on the display is dragged by manipulating the mouse to a position where a right lower vertex of the rectangular area 602 is desired to be formed, and the main button is released, thus enabling the encrypting target area to be designated. The selection of the area, which is desired to be set as the encrypting target area, may involve using other methods. It should be noted that the area designating information according to the embodiment enables the overlapped areas to be designated. A process in the case of designating the plurality of areas overlapped with each other will be described in detail later on.

Incidentally, in the area designating information according to the embodiment, the encrypting target area different on a per-page basis can be, with respect to the electronic data extending over a plurality of pages, set by combining pieces of page number information with pieces of intra-page positional information. Therefore, when the electronic data extends over the plurality of pages, a so-called thumbnail 604 is displayed as a page list, whereby a listing property to the user may be enhanced. After designating the encryption area, the processing advances to step S105.

In steps S105 and S106, the authorized user is designated. Herein, the term “authorized user” connotes the user having the authority for using a decryption key associated with a predetermined encryption key to thereby enable the user to browse the area encrypted by employing the predetermined encryption key in a way that decrypts the encrypted area in the image processing system 100. In the embodiment, the user is managed by the image processing system 100. The user terminal 112 displays on the display the selectable user list of which the image processing system 100 notifies (step S105), and accepts an input of a result of the user's selection through the input device (step S106). To be specific, the user designates the authorized user by selecting the user desired to browse the decrypted content of the conversion area. Note that if the plurality of encryption areas is designated in step S104, the user can designate the authorized user different per designated encryption area.

It should be noted that the user to be designated is selected from the user list transmitted from the image processing system 100 in the embodiment, however, the user list may be a user list that is not transmitted from the image processing system 100, and the authorized user may not be designated by the method of selecting the authorized user from the user list. For example, an available scheme is that on the user terminal 112, the user inputs the information (such as a name and an identification number of the user desired to be authorized to browse) from which the user can be identified, then the inputted information is transmitted to the image processing system 100, and the authorized user is specified by searching through the user list. Thereafter, the processing advances to step S107.

Moreover, in the process illustrated in the present flowchart, the user designates the encryption area by performing the operation of selecting the range while looking at the preview screen 600 and further designates the authorized user by designating the user desired to be authorized to browse, however, a substitute for this scheme may involve detecting a keyword in the electronic data, determining the encryption area on the basis of the keyword and further setting the authorized user associated therewith. The keyword is detected from the encrypting target electronic data, and the associated area is automatically encrypted, whereby a workload for encrypting the information described in a variety of formats can be reduced. Specifically, the system previously retains a combination of the keyword and the authority level or a combination of the keyword and the authorized user, and the predetermined authority level and the authorized user associated with the authority level are set corresponding to a content of the keyword detected through the keyword detection, whereby the information having a higher degree of importance can be encrypted at the higher authority level, while the information having a lower degree of importance can be encrypted at a relaxed level.

In steps S107 and S108, the various items of information needed for the encryption in the image processing system 100 are transmitted to the image processing system 100 from the user terminal 112. The user terminal 112 transmits, to the image processing system 100, the various items of information such as the electronic data information, the area designating information and the authorized user information designated in the processes up to step S106, which are needed for encrypting the electronic data (step S107). The image processing system 100 receives the various items of information transmitted from the user terminal 112 and records the received information in the RAM 102 (step S108). More specifically, the electronic data accepting unit 17 accepts the electronic data specified in step S103, and the area designating information acquiring unit 19 acquires the area designating information designated in step S104. Thereafter, the processing advances to step S109.

In step S109, the digital image is generated. The digital image acquiring unit 15 generates bitmap data of the print image or the display image on the basis of the accepted electronic data, thus acquiring the digital image. Thereafter, the processing advances to step S110.

In step S110, the encryption sequence of the overlapped encryption areas is determined. The encrypting unit 11, if the acquired area designating information specifies the plurality of encryption areas overlapped with each other, determines the encryption sequence of the encryption areas according to the predetermined rule. In the embodiment, the encrypting unit 11, if the encryption areas overlapped in their areas are the encryption areas related to the authorized users different from each other, determines the encryption sequence so that the encryption area related to the user having the higher-level of browsing authority is encrypted much earlier. This contrivance intends to prevent such a futile process that the encryption area related to the high-level authority must be temporarily decrypted in order to decrypt the conversion area related to the lower-level of authority with a scheme that the conversion area related to the user having the lower-level of browsing authority can be decrypted ahead when in the decrypting process.

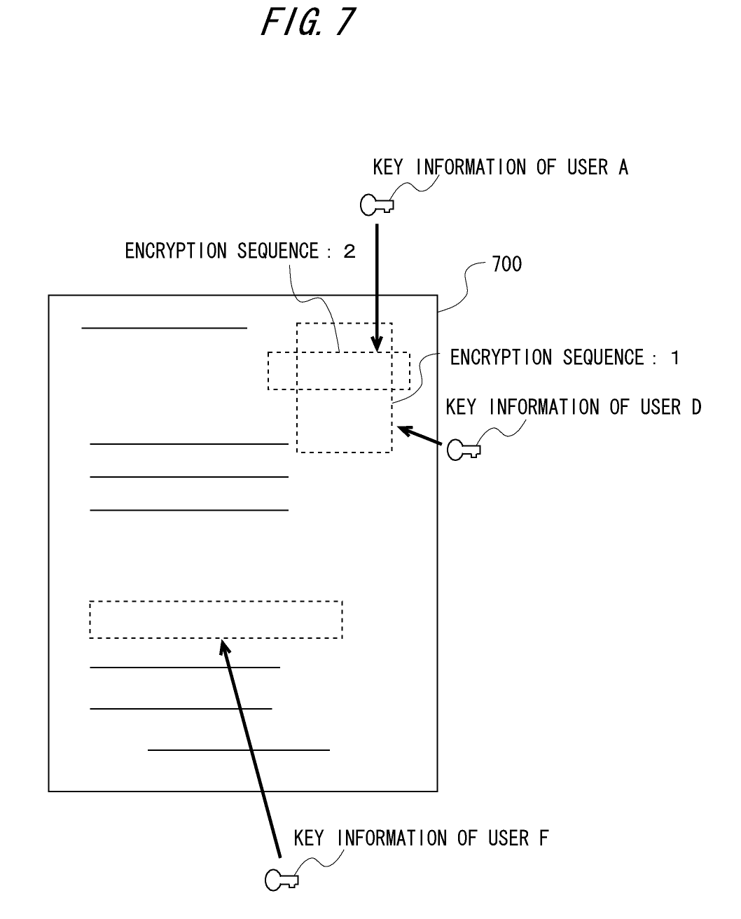

FIG. 7 is a diagram illustrating a display image of a digital image 700 which is encrypted by use of a plurality of encryption keys. In the digital image 700 depicted in FIG. 7, three encryption areas are designated, and users A, D and F are set as the authorized users related to the respective areas. Note that the authority level assigned to the user is based on the key information table illustrated in FIG. 3. Herein, the area in which the authorized user is the user A is (partially) overlapped with the area in which the authorized user is the user D. Hence, the encrypting unit 11 encrypts earlier the encryption area related to the user D having the higher-level of authority and, thereafter, encrypts the encryption area related to the user A. Incidentally, an encryption sequence problem does not arise in the encryption of the encryption area concerning the user F because of not being overlapped with other areas.

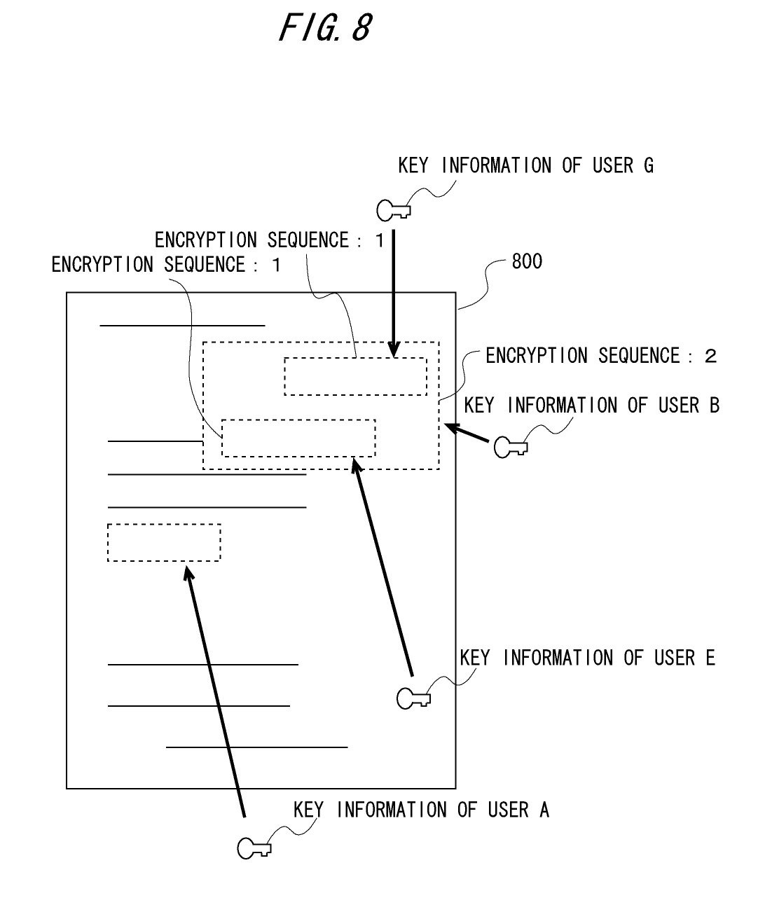

FIG. 8 is a diagram illustrating a display image of a digital image 800 which is encrypted by use of the plurality of encryption keys. In the digital image 800 depicted in FIG. 8, four encryption areas are designated, and the users A, B, E and G are set as the authorized users related to the respective areas. Note that the authority level assigned to the user is based on the key information table illustrated in FIG. 3. Herein, the area in which the authorized user is the user B is partially overlapped with the area in which the authorized user is the user E and the area in which the authorized user is the user G. Therefore, the encrypting unit 11 encrypts earlier the encryption areas related to the users E and G having the higher-level of authority and, thereafter, encrypts the encryption area related to the user B. Note that the encryption sequence problem is not caused in between the encryptions of the encryption areas related to the users E and G because of their areas not being overlapped with each other.

If one encryption area of the encryption areas overlapped in their areas is completely embraced by the other encryption area, however, the encrypting unit 11 may encrypt one encryption area earlier that is embraced by the other encryption area irrespective of the browsing authority levels of the authorized users. This is because if the other encryption area is set to be encrypted later on and in the case of desiring to decrypt and browse only the partial area, not overlapped with one encryption area, of the other encryption area, such a necessity arises as to temporarily decrypt both of the encryption areas and again encrypt or mask one encryption area. If one encryption area is set to be encrypted ahead, only the partial area, not overlapped with one encryption area, of the other encryption area can be browsed only by decrypting the other encryption area when in the decrypting process.

In step S111, the encryption key is acquired. The key information acquiring unit 22 searches through the pieces of key information accumulated in the key information storage unit 21 by using the user ID of the authorized user that is designated in step S106 and received in step S108, thereby acquiring the key information (which is herein the encryption key) about the authorized user. Herein, if the plurality of authorized users is designated, the key information acquiring unit 22 makes the plurality of searches, thus acquiring the encryption keys related to all of the authorized users. Thereafter, the processing advances to step S112.

In step S112, the encrypted image is generated by conducting the encryption. The encrypting unit 11 encrypts the encryption area, designated by the area designating information specified in step S104, of the digital image generated in step S109 by employing the encryption key acquired in step S111. Note that if the plurality of encryption areas is designated, the execution of the encryption involves using the encryption key, associated with the authorized user related to each encryption area, of the plurality of encryption keys acquired in step S111. Further, if the encryption areas overlapped with each other exist, the encryption is carried out according to the encryption sequence determined in step S110. Thereafter, the processing advances to step S113.

In step S113, a process of adding or storing the area designating information is executed. Herein, the area designating information adding process is a process of adding, to the encrypted image, the area designating information for specifying the position etc of the conversion area in the encrypted image to thereby facilitate the acquisition of the position etc of the decrypting target conversion area when in the decrypting process. The area designating information adding unit 23 adds the area designating information for designating the encrypted area to the encrypted image generated in step S112. The area designating information may be added as an image to within the encrypted image so as to be displayed together with the encrypted image when printed on the paper medium and when displayed on the display, and may also be added as so-called metadata to within the data of the encrypted image. If added in the way of being displayed together with the encrypted image, the area designating information can be read by means such as an OCR (Optical Character Reader) and a barcode reader also on the occasion of reading the encrypted image temporarily output to the paper medium and decrypting the encrypted image.

Moreover, the area designating information storing process is a process of accumulating, in the area designating information table, the area designating information for specifying the position of the conversion area in the encrypted image to thereby facilitate the acquisition of the position of the decrypting target conversion area. The area designating information accumulating unit 16 accumulates, in the area designating information table, the area designating information for designating the encrypted area in the way of being associated with items of identifying information (e.g., a file name, an identifier of the encrypted image that is embedded in the metadata, an identifier added to within the metadata and readable by the OCR and the barcode reader, and so on) for identifying the encrypted image generated in step S112 (see FIG. 4). This contrivance enables the decrypting target area designating information to be acquired in a way that seeks out the area designating information associated with the encrypted image by making the search with the information for identifying the encrypted image serving as a search key when in the decryption.

Note that the area designating information to be added or stored contains, in addition to the information specifying the position of the area, the information specifying the authorized user related to the area. The area designating information adding unit 23 or the area designating information accumulating unit 16 adds or stores, with respect to the area designating information, the user ID of the user (designated as the authorized user of the area in step S106) associated with the encryption key used for the conversion area designated by the area designating information to or in the encrypted image in the way of being included in the area designating information in order to acquire the authorized user per conversion area when in the decryption.

Furthermore, the area designating information to be added or stored may contain the information designating the encryption sequence (or the decryption sequence) of the areas. When the encryption sequence is determined in step S110 and if encrypted in this sequence, the area designating information adding unit 23 or the area designating information accumulating unit 16 adds or stores the encryption sequence or the decryption sequence together with the information indicating the position of the area. Herein, a sequence designating format may be properly adopted according to the embodiment. The sequence designating format may involve adopting a format of adding or storing the numbers when encrypted (decrypted) together with the information indicating the position of each area (see FIG. 4) and a format of adding or storing the pieces of information for identifying the respective areas in a way that arranges these pieces of information in the encryption (decryption) sequence. After executing the process of adding or storing the area designating information, the processing advances to step S114.

In step S114 and step S115, the encrypted image is output. The output unit 18 transmits the encrypted image containing the conversion area encrypted in step S112 to the user terminal 112 (step S114). The thus-transmitted encrypted image is received by the user terminal 112 (step S115) and stored as an electronic file in the user terminal 112 or printed on the paper medium. Through this operation, the user can encrypt the designated area in the electronic data, which can be decrypted only by the designated authorized user, and can distribute or browse a document (which may be formed as the electronic file or the paper medium). Thereafter, the processes given in this flowchart are finished.

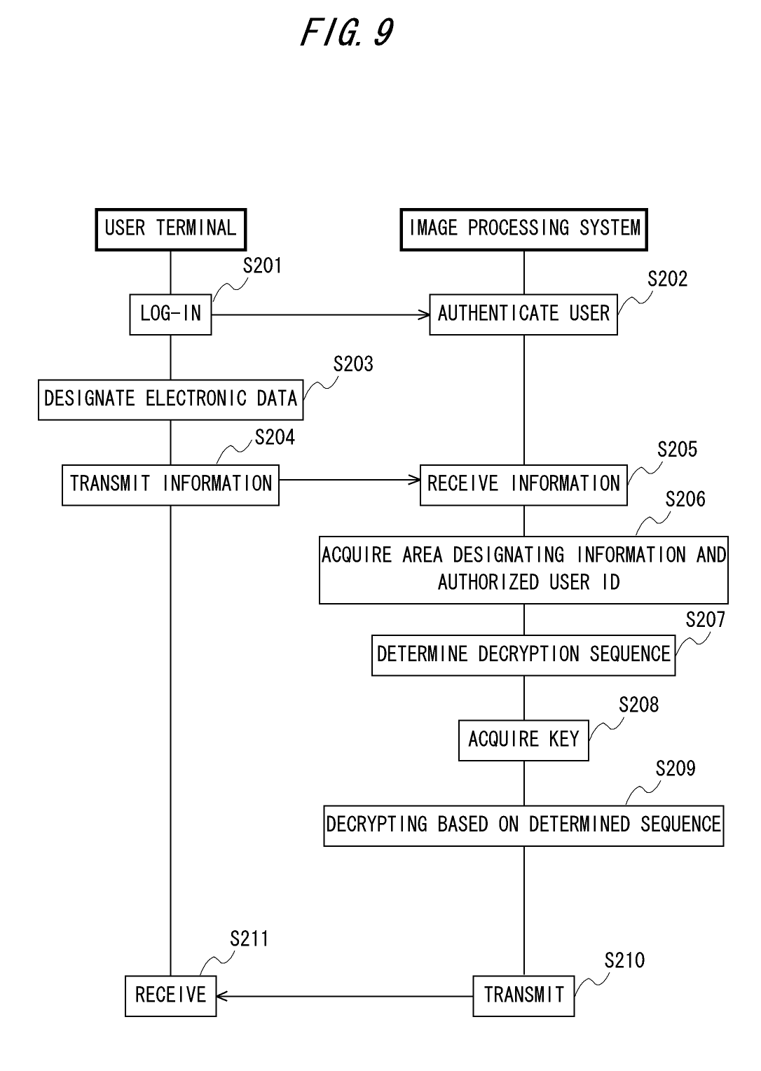

FIG. 9 is a sequence diagram illustrating a flow of an encrypted image decrypting process according to the embodiment. The encrypted image decrypting process is started by an event that the user logs in the image processing system 100 by operating the user terminal 112 employed for transmitting the electronic data containing the want-to-decrypt encrypted image.

In steps S201 through S203, the log-in process is carried out, and the decrypting target electronic data is designated. The details of the log-in process are the same as in steps S101 and S102, and hence the description thereof is omitted. After executing the log-in process, the user terminal 112 determines, based on the user's operation, the electronic data containing the want-to-decrypt encrypted image from the electronic data retained on the user terminal 112 or the electronic data inputted from the outside (e.g., the scanner 106) (step S203). Thereafter, the processing advances to step S204.

In step S204 and S205, the user terminal 112 transmits the various items of information needed for the encryption in the image processing system 100 to the image processing system 100. The user terminal 112 transmits the information such as electronic data information designated in step S203, which is necessary for decrypting the electronic data, to the image processing system 100 (step S204). Note that in the process illustrated in this sequence diagram, the area designating information is acquired in step S206 which will be explained later on, however, the decrypting target conversion area may be designated by the user terminal 112 and transmitted to the image processing system 100. If the conversion area is designated by the user terminal 112, the user can be made to designate the decrypting target conversion area via the same interface as the preview screen 600 depicted in FIG. 6. The image processing system 100 receives the information transmitted from the user terminal 112 (step S205) and records the information in the RAM 102. Thereafter, the processing advances to step S206.

In step S206, the area designating information and the authorized user ID of the conversion area specified by area designating information are obtained. The area designating information acquiring unit 19 acquires the area designating information added to the encrypted image and the user ID of the authorized user by reading the area designating information added to the encrypted image or seeking out the area designating information accumulated by the area designating information accumulating unit 16. To be specific, the area designating information acquiring unit 19, in the case of acquiring the information from the information added to the encrypted image, acquires these items of information by a method of reading the file header information (metadata) of the encrypted image and by a method of performing the OCR/barcode reading process of the information displayed in the encrypted image. Further, the area designating information acquiring unit 19, in the case of seeking out the information from the area designating information table, acquires the information by a method of searching through the area designating information table, in which the identifying information of the encrypted image is used as the search key. Thereafter, the processing advances to step S207.

In step S207, if the acquired area designating information indicates the plurality of conversion areas overlapped with each other, the decryption sequence of the overlapped conversion areas is determined. The decrypting unit 14 determines the decryption sequence according to the encryption sequence contained in the area designating information acquired in step S206. Note that if the information contained in the area designating information is the encryption sequence, the decryption sequence is reversal to the encryption sequence. Thereafter, the processing advances to step S208.

In step S208, the decryption key is obtained. The key information acquiring unit 22 searches for the key information accumulated in the key information storage unit by employing the user ID of the authenticated user authenticated in steps S201 and S202, thereby acquiring the key information (which is herein the decryption key) about the authenticated user. Further, the key information acquiring unit 22 obtains the authority level of the authenticated user, and acquires the decryption key related to the conversion area, in which the user having the lower authority level than the authority level of this authenticated user is designated as the authorized user, of the conversion areas contained in the encrypted image. More specifically, the key information acquiring unit 22 obtains the authority level of the authenticated user from the key information table, and further acquires the decryption key of the user assigned the lower authority level than the obtained authority level, thereby obtaining the decryption key about the conversion area in which the user having the lower authority level is designated as the authorized user. Thereafter, the processing advances to step S209.

In step S209, the decryption is conducted, and the digital image is generated. The decrypting unit 14 decrypts, within the conversion area specified by the area designating information acquired in step S206, the area related to the user ID of the authenticated user and the area related to the user ID of the lower-level user than the authenticated user by use of the decryption key acquired in step S208. Note that the decrypting process involves executing the decryption by using the decryption key of the authenticated user and the decryption key of the user having the authority level lower than the authority level of the authenticated user, which are obtained in step S208. This scheme enables the authenticated user to decrypt, in addition to the area where the authenticated user himself or herself is designated as the authorized user, the area in which another user having the lower authority level is designated as the authorized user and to browse the contents thereof. However, the authenticated user can browse neither the contents of the area in which the user having the same authority level as that of the authenticated user but associated with a different decryption key is designated as the authorized user nor the area where the user having the higher authority level than that of the authenticated user is designated as the authorized user. Moreover, if there are the conversion areas overlapped with each other, the decryption is conducted according to the encryption sequence determined in step S207. Thereafter, the processing advances to step S210.

In steps S210 and S211, the decrypted digital image is output. The output unit 18 transmits the digital image including the areas decrypted in step S209 to the user terminal 112 (step S210). The transmitted digital image is received by the user terminal 112 (step S211) and stored as the electronic file in the user terminal 112 or printed on the paper medium. This scheme enables the user to browse the contents (unencrypted contents) of the area of which the browsing authority is held by the user himself or herself in the encrypted conversion areas in the electronic data. Thereafter, the processes illustrated in the flowchart are finished.

The image processing system 100 according to the embodiment can encrypt and distribute only the want-to-conceal area in the document including the important information and enables only the user having the browsing authority to browse the pre-encrypting contents of the encrypted area. Moreover, the image processing system 100 according to the embodiment enables the user to manage, based on the management of the key information explained with reference to the sequence diagram given above, the browsing authority (access right) without being aware of saving and selecting the key information.

Note that the image processing system 100 according to the embodiment may attach a marker in the vicinity of an outer edge of the conversion area in order to facilitate pinpointing of the position of the encrypted conversion area. An in-depth description of how the marker is attached will be made later on. Herein, the image processing system 100 according to the embodiment determines the decryption sequence in the case of the overlapped conversion areas according to the encryption sequence included in the area designating information and may also determine the decryption sequence according to a type of the marker. To be specific, the decryption sequence and a shape of the maker used per authority level are previously determined, and the decrypting unit 14 can determine the decryption sequence by deciding the type of the marker attached to the conversion area in the image. In this case, the encryption sequence may not be included in the area designating information.

Further, according to the embodiment, the important information can be prevented from leaking out. Moreover, it is feasible to obtain an effect that the encrypted image is output onto the paper medium and gets deteriorated in the case of making a copy by employing a copying machine etc with the result that the decryption thereof is disabled if copied repeatedly. This contrivance can prevent the important information from leaking out in the form of the easily copied important documents through the copying machine. Further, a possible scheme is that the paper medium on which the encrypted image is printed involves using a special paper medium (so-called copy forgery preventive paper) in which a character image [Copy] etc appears when copied by the copying machine etc, or such a latent character image is printed simultaneously with printing the encrypted image, thereby restraining an easy copy and disabling the decryption from the copy due to noises being embedded in the encrypted image by an overlap of the sensitized character image.

### <Encrypting Unit and Decrypting Unit>

Next, outlines of the encrypting process of the encrypting unit and the decrypting process of the decrypting unit in first through fourth embodiments will be discussed.

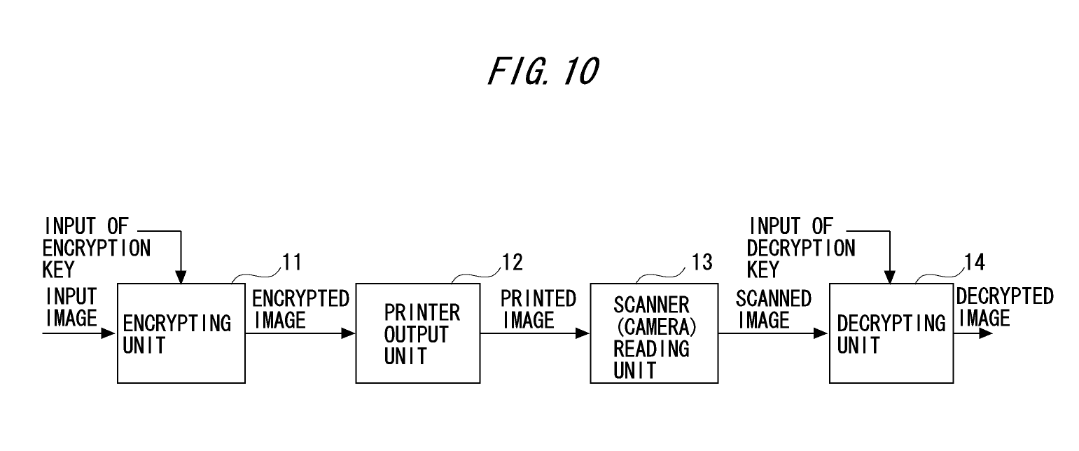

FIG. 10 is a diagram showing a processing outline (part 1) of the encrypting process and the decrypting process. In FIG. 10, the encrypting unit 11 (which is referred to as an encrypting unit 11A, encrypting unit 11B and an encrypting unit 11C in first through third modes, respectively) outputs the encrypted image into which part of the digital image has been encrypted on the basis of the inputted digital image and the encryption key specifying the encrypting method. The printer output unit 12 prints the digital image encrypted by the encrypting unit 11 on a printable physical medium such as the paper. The scanner (camera) reading unit 13 reads the printed image output by the printer output unit 12 by employing the scanner or the camera.

Then, the decrypting unit 14 (which is termed a decrypting unit 14A, a decrypting unit 14B and a decrypting unit 14C in the first through third modes, respectively) obtains the printed image output by the printer output unit and the decrypted image with the inputted decryption key. As far as the inputted decryption key is valid, the encrypted image can be properly decrypted, and the information hidden with the encryption by the encrypting unit 11 gets visible.

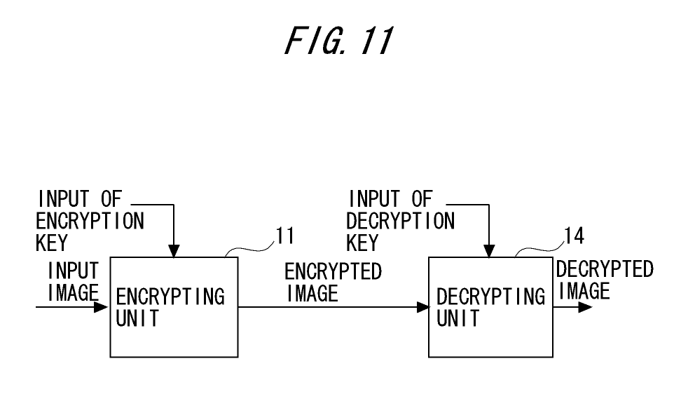

FIG. 11 is a diagram showing a processing outline (part 2) of the encrypting process and the decrypting process. As shown in FIG. 11, the encrypting process and the decrypting process in the first through third modes to which the present invention is applied, enable the decrypted image to be acquired by inputting the digital image encrypted by the encrypting unit 11 in an as-is state of the electronic document image without via the printer and the scanner to the decrypting unit 14.

Next, the first through the third modes to which the present invention is applied will be described, respectively. To begin with, the first mode to which the present invention is applied will be described.

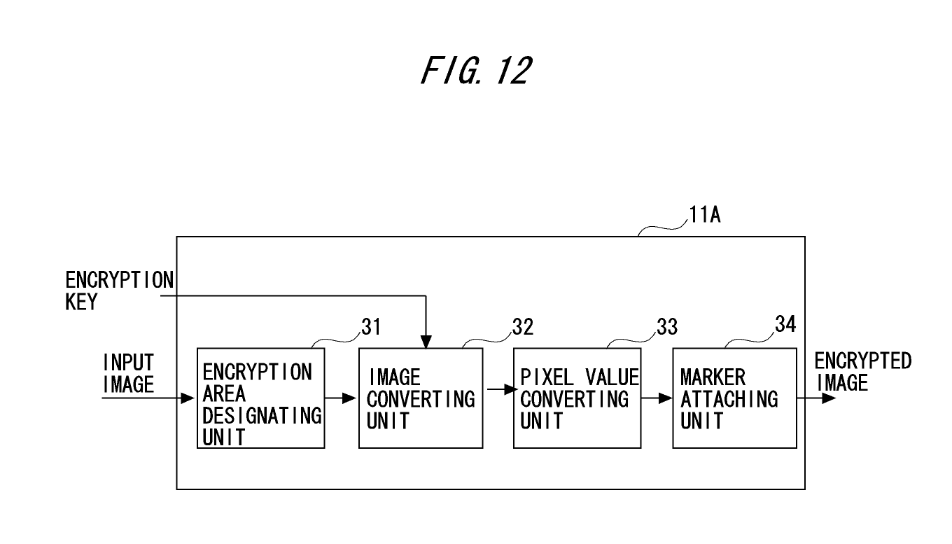

FIG. 12 is a diagram illustrating an outline of the encrypting process in the first mode. In FIG. 12, the encrypting unit 11A includes an encryption area determining (designating) unit 31, an image converting unit 32, a pixel value converting unit 33 and a marker adding unit 34.

The encryption area designating (determining) unit 31 selects an area to be encrypted from the inputted image containing the want-to-encrypt area.

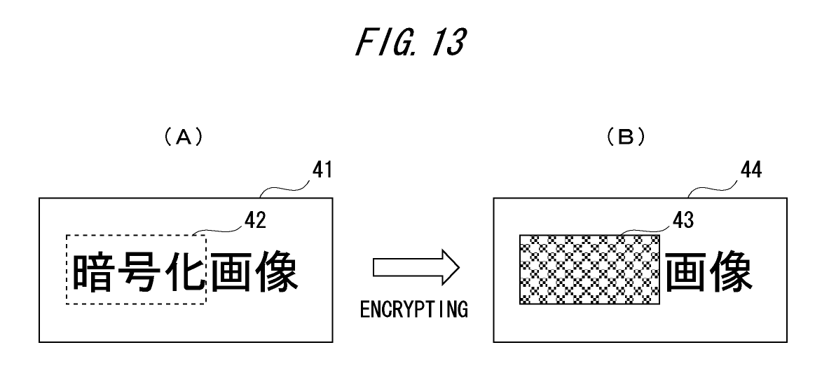

FIG. 13 is a diagram showing an example of selecting the encryption area. To be specific, the encryption area designating unit 31 selects, as illustrated in (A) of FIG. 13(A), an area 42 to be encrypted out of a digital image (inputted image) 41 containing the want-to-encrypt area. The area 42 is converted into a converted image 43 as illustrated in (B) of FIG. 13 by the processes of the image converting unit 32 and the pixel value converting unit 33 that will hereinafter be described, and the digital image 41 is converted into an encrypted image 44 containing the converted image 43.

The discussion gets back to the description in FIG. 12. When the encryption area designating unit 31 selects the area 42 to be encrypted, the image converting unit 32 inputs the to-be-encryption area 42 and the encryption key, and visually converts the an image of the to-be-encryption area 42 by a converting method associated with the encryption key. A conversion parameter on this occasion is generated based on binary data obtained from the inputted encryption key.

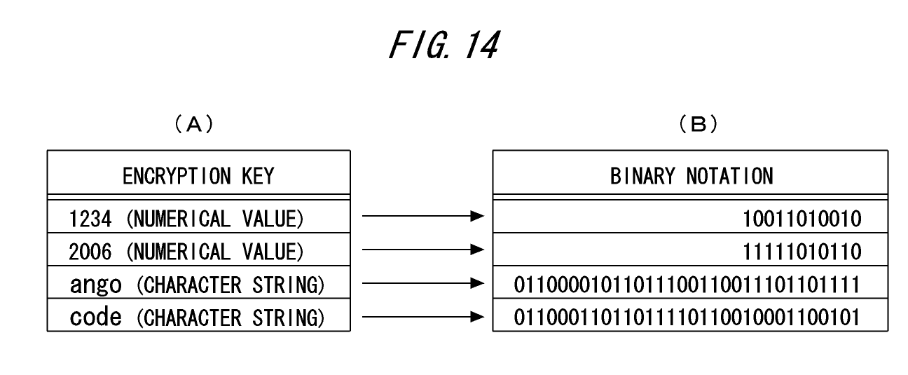

FIG. 14 is a diagram showing an example of inputting the encryption key. FIG. 14 shows an example of the encryption key and an example of the binary data generated from the encryption key. For example, a numeric value [1234] used as the encryption key is inputted in the form of binary data [100011010010], and a character string [ango] as the encryption key is inputted in the form of binary data [01100001011011100110011101101111].

The first mode exemplifies, as the image converting methods, two converting methods, i.e., one method based on a process (called a scramble process) of segmenting the image into micro areas and rearranging the micro areas and another method based on an image compression process.

To start with, the scramble process will be described. The scramble process is that at first the image of the selected area 42 is segmented into the micro areas each having a fixed size, and next the micro areas are rearranged based on the binary data obtained from the encryption key.

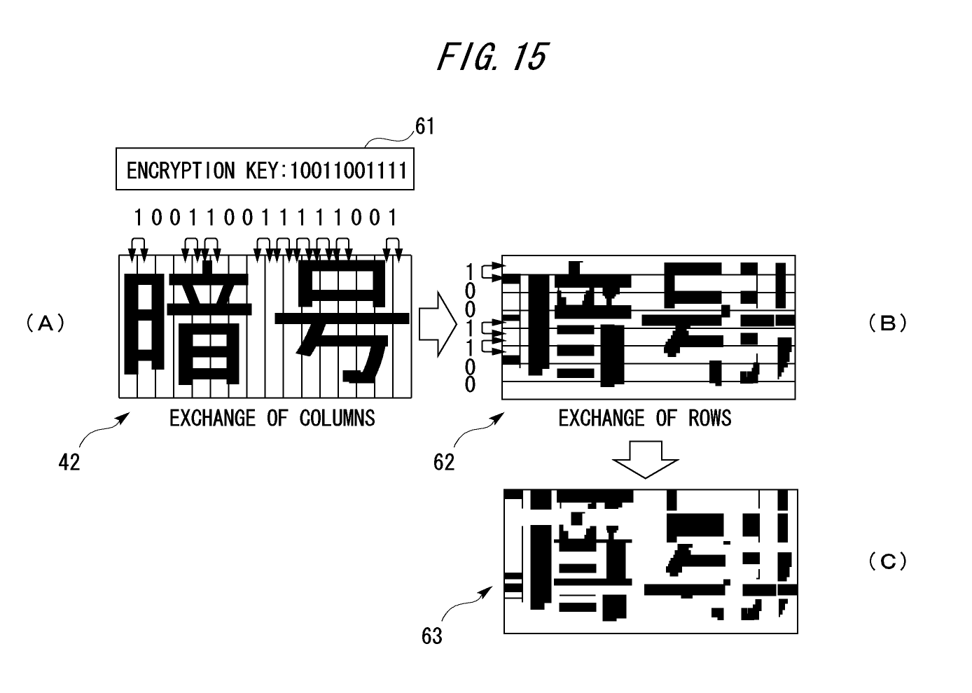

FIG. 15 is a diagram showing one example of the scramble process by the image converting unit. As shown in (A) of FIG. 15, at the first onset, the area 42 selected by the encryption area designating unit 31 is segmented in a vertical direction, respective bits of a binary string of the encryption key 61 are set corresponding to borders between the segmented areas (micro areas) 42 in sequence from the left, when the bit is [1], neighboring segmented columns (segmented areas) are exchanged with each other, and, when the bit is [0], an execute-nothing-process is conducted in sequence from the left side. If the bit count of the binary string is insufficient for a segmentation border count, the same binary string is repeated from a position where the insufficiency occurs, thus performing the exchanging process up to the right end of the area 42.

Subsequently, as shown in (B) of FIG. 15, an image area 62 undergoing the exchange process is segmented in a horizontal direction, the respective bits of the binary string of the encryption key 61 is set corresponding to the boarders between the segmented image areas 62 in sequence from above, and the same exchanging process as done for the vertical segmentation is executed sequentially from above on a row-by-row basis.

Then, as illustrated in (C) of FIG. 15, as a result of executing the exchanging process on the individual segmented images, a scramble image 63, defined as a processed image into which the original area 42 has been subjected to the scramble process, is acquired.

An extension method of this exemplified scramble process can involve executing the scramble process twice or more both in the horizontal direction and in the vertical direction, and can further involve changing the size of the segmented area in the exchange conducted from the second time onward. Moreover, different binary strings can be also employed for exchanging the segmented areas in the horizontal direction and in the vertical direction. These extension methods are, if a size of the inputted image is small while a bit length of the encryption key is large, effective especially as a means for preventing absolutely the same processed image from being generated based on the different encryption key.

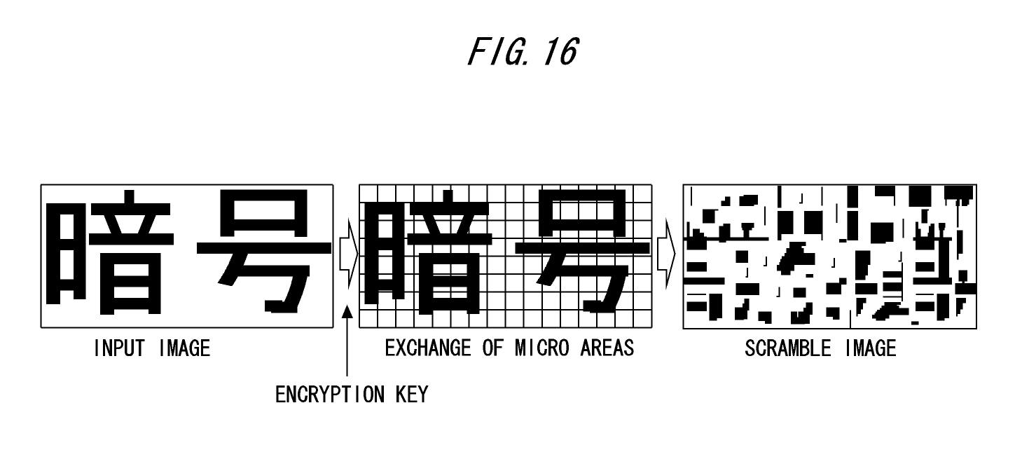

FIG. 16 is a diagram illustrating another example of the scramble process in the image converting unit. A method of exchanging the pixels on the unit of the micro area as illustrated in FIG. 16 can be used as another scramble processing method different from the scramble process explained with reference to FIG. 15. More specifically, the inputted image is segmented into the micro areas each taking a rectangular shape, and the segmented micro areas are exchanged with each other. This scheme has a greater scrambling count and enables strength of the encryption to a greater degree than by the method of conducting the exchanges in the horizontal direction (row) and in the vertical direction (column) described above.

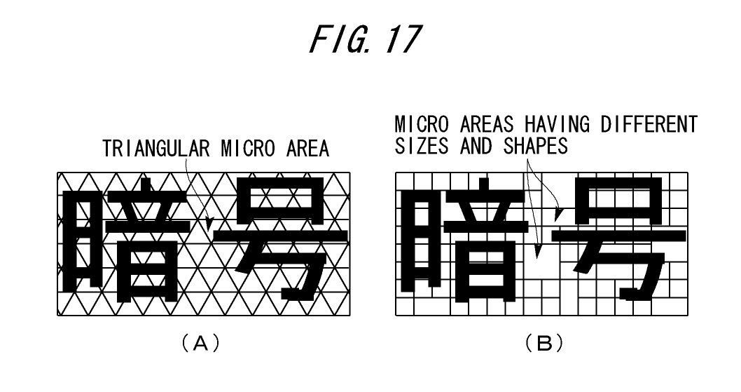

FIG. 17 is a diagram showing modified examples of the shape of the micro area in the scramble process. Further, the shape of the micro area when executing the scramble process can include, e.g., a triangle as illustrated in (A) of FIG. 17 in addition to the rectangle illustrated in FIG. 16. Moreover, as illustrated in (A) of FIG. 17, the micro areas having different shapes and different sizes can coexist as shown in (B) of FIG. 17.

Next, the converting method based on the image compressing process will be described.

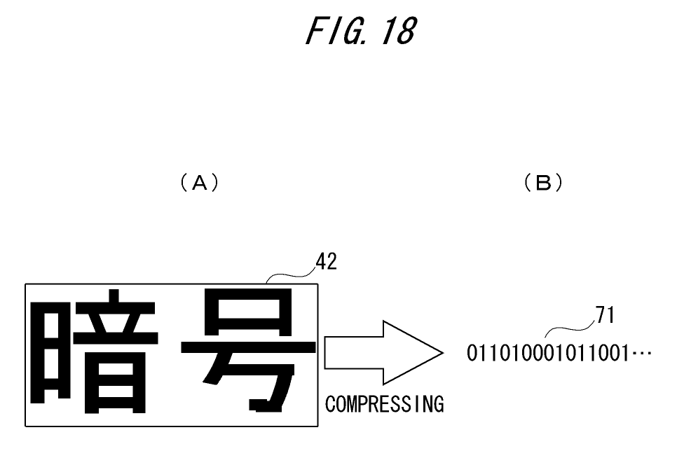

FIG. 18 is a diagram showing a compression process in the image converting unit. When the input image 41 is a binary image, at first, as illustrated in (A) of FIG. 18, a binary string 71 as shown in (B) of FIG. 18 is generated by compressing an image of the area 42 selected by the encryption area designating unit 31. A compression method herein can involve applying all types of compression methods such as a run-length compression method used for transferring binary image data in a facsimile apparatus and a JBIG (Joint Bi-level Image experts Group) compression method defined as a standard compression method for the binary image.

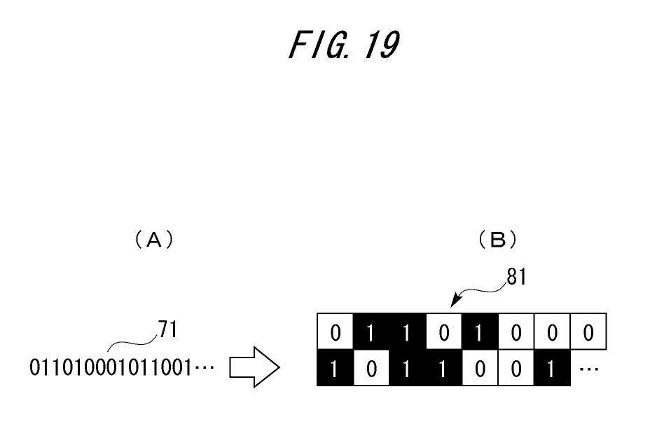

FIG. 19 is a diagram showing a process of transforming the converted data into the images. As shown in FIG. 18, subsequent to the compression of the area 42, the respective bits of the binary string 71 defined as the converted compression data are arrayed as black-and-white square images 81 in the area 42 of the image to be encrypted in a way that generates the square images (processed images) 81 by enlarging [0] bits as [white] squares and [1] bits as [black] squares in a designated size as illustrated in (B) of FIG. 19.

If desired to array the converted compression data (binary string 71) within the image of the selected area 42, the size of the square image 81 depends on a compression rate of the selected area 42. For example, if the compression rate is equal to or smaller than ¼, the size of the square image 81 is equivalent to (2×2) pixels at most, and, if equal to or smaller than 1/16, the size is equivalent to (4×4) pixels at most.

On the other hand, if desired to designate the size of the square image 81 and to arrange the compressed data within the image of the area 42, it is necessary for attaining a compression rate depending on the size of the square image 81 in the first image compression process. In the case of setting the square to, e.g., a (4×4) pixel size, the compression rate equal to or larger than 1/16 is needed. In this case, effective methods are a method of previously compressing the information in the selected area 42 and an irreversible compression method.

The encryption process of transforming the compressed data into the image in enlargement enables the enlarged black-and-white blocks to be recognized even when reading the encrypted image with, e.g., a low-resolution camera, and hence the encrypted image can be correctly decrypted.

The discussion gets back to the illustration in FIG. 12. A pixel value converting unit 33 converts at the fixed intervals the pixels within the processed image 63 converted by the image converting unit 32, thus making the converted image 43 take substantially a grating-shaped stripped pattern.

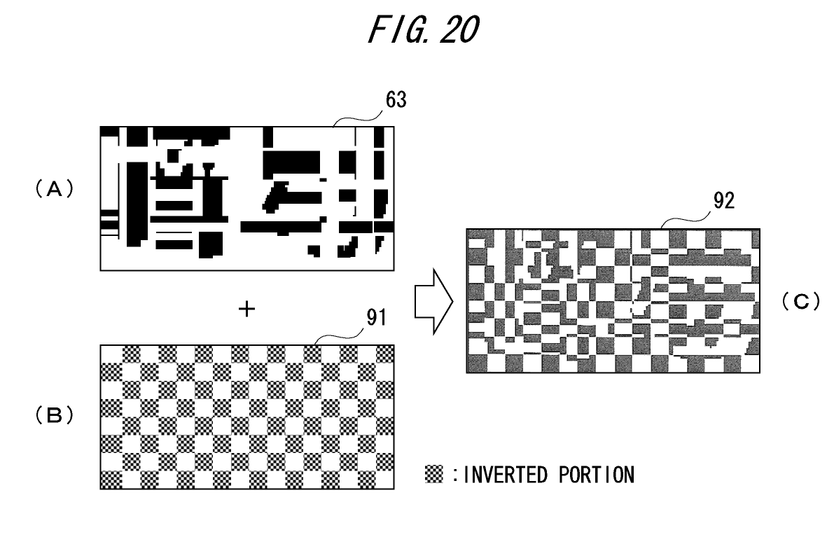

FIG. 20 is a diagram showing an example (part 1) of a pixel value converting process. The pixel value converting unit 33 converts at the fixed intervals the pixels of the processed image 63 into which the area is scrambled by the image converting unit 32, whereby the encrypted image 44 takes substantially the grating-shaped stripped pattern as a whole. For example, as illustrated in FIG. 20, a converted image 92 in which the encrypted image 44 takes substantially the grating-shaped stripped pattern on the whole is acquired as shown in (C) by executing such conversion that the scramble image 63 shown in (A) of FIG. 20 is inverted (inversion process) with colored portions of a checkered pattern image 91 illustrated in FIG. (B). The stripped pattern to be generated is thereby used for detecting minute positions of the respective pixels within the encryption area when decrypting the encrypted image 44.

Another conversion can be carried out for a series of these processes. For example, the process of inverting the pixel values may also be a process of adding a designated value.

Further, a checkered pattern image 91 illustrated in (B) of FIG. 20 has substantially the same size as the scramble image 63 shown in (A) has, however, only the central area, excluding the peripheral area, of the scramble image 63 may also be subjected to the inverting process.

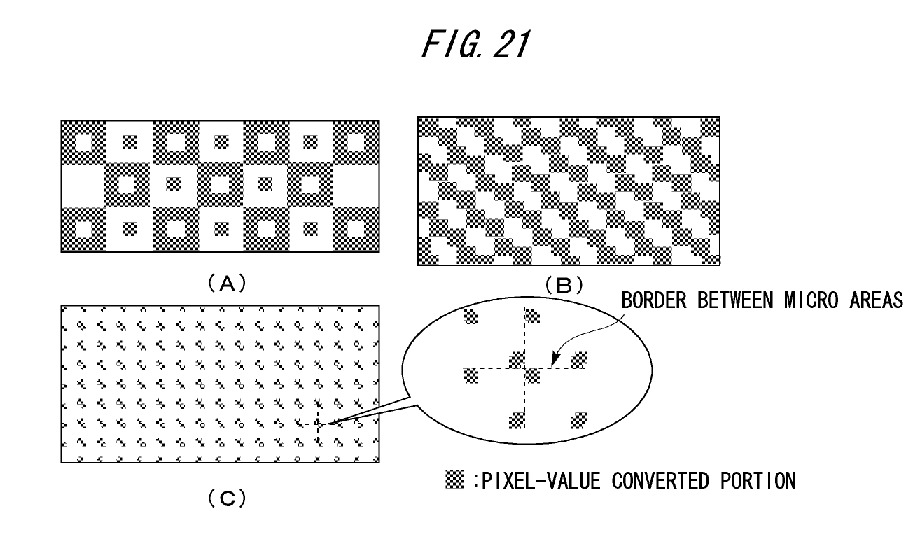

FIG. 21 is a diagram showing an example (part 2) of the pixel value converting process by the pixel value converting unit. Moreover, a variety of shapes as illustrated in (A) through (C) of FIG. 21 can be applied to the area 42 in which to convert the pixel values. The conversion of the pixel values is a process aiming at detecting the border position between the micro areas with the high accuracy, and hence it is considered that, e.g., as in (A) of FIG. 21, only the border portions are pixel-value-converted. Further, as in (B) of FIG. 21, the borders between the conversion and the non-conversion appear at much minuter intervals by converting the pixel values while shifting little by little with respect to the micro areas, whereby the positions of the pixels of the encrypted image 44 can be detected in much greater detail in the decrypting process. Moreover, as in (C) of FIG. 21, only portions, in which the borders between the micro areas, are pixel-value-converted, thereby enabling deterioration of an image quality to be restrained to the minimum when reading and decrypting the images printed on a sheet of paper etc with the scanner and the camera.

Herein, such a postscript is added that if the shape of the micro area is not the square having a uniform size and if the micro areas are triangular ((A) of FIG. 17) of if the micro areas having different sizes and different shapes coexist (B) of FIG. 17), the pixel values are required to be converted by methods corresponding to the shapes without being limited to the conversion examples given above.

As described above, the present invention takes not the scheme that the regular patterns representing the encrypted positions are generated in the way of being overwritten on the inputted image as in Patent document 1 but the scheme that the regular patterns are generated by converting the pixel values of the inputted image. Accordingly, it does not happen that the image information of the edge portions of the encrypted image are sacrificed as by the prior arts, and the encryption can be done at the high efficiency in the form of making the position detecting information coexist with the original image information.

Note that if the pattern forming portions contain some pieces of image information, the regularity thereof is lost more or less, however, as will be mentioned about he process of the decrypting unit 14 that will be described later on, the encrypted positions can be detected by making use of statistical characteristics of the whole encrypted image.

The discussion gets back to the illustration in FIG. 12. The marker adding unit 34 adds positioning markers to, e.g., three corners other than the right lower corner among the four corners of the converted image 92 undergoing the converting process by the pixel value converting unit 33, thereby generating the encrypted image 44.

The marker adding unit 34 allocates the positioning markers for specifying the position of the encryption area 42 to the three corners excluding the right lower corner among the four corners of the converted image 92.

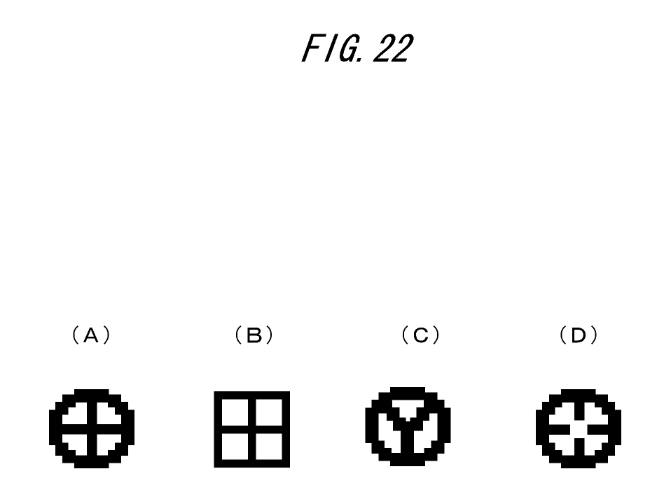

FIG. 22 is a diagram illustrating examples of the positioning markers used for the encryption process. The positioning marker used in the first mode takes, it should be assumed, a circled cross as illustrated in (A) of FIG. 22. The shape of the positioning marker may be in a broader sense formed by the circle or a polygon of a solid line and a plurality of lines intersecting the periphery thereof. This is exemplified such as a shape of [intra-square cross] which resembles kanji character [H] used as the positioning marker in (B) of FIG. 22, a circled Y consisting of three lines extending radially toward the periphery from the center as in the case of the positioning marker in (C), and a circled centrally-voided cross (lines disconnected at the center) as in the case of the positioning marker in (D).

Moreover, a color combination of the positioning marker may be such that most simply the background is white, while the foreground is black, however, it does not cause any inconvenience to properly change the color combination corresponding to a color (pixel values) distribution of the converted image 92 without being limited to the color combination given above. Further, a thinkable method is not that the determined colors are designated for the background and the foreground but that the positioning marker is formed by inverting the pixels values of the foreground while the background color is set to an as-is color of the digital image 41. With this contrivance, the image is encrypted while retaining the input image information of the positioning marker.

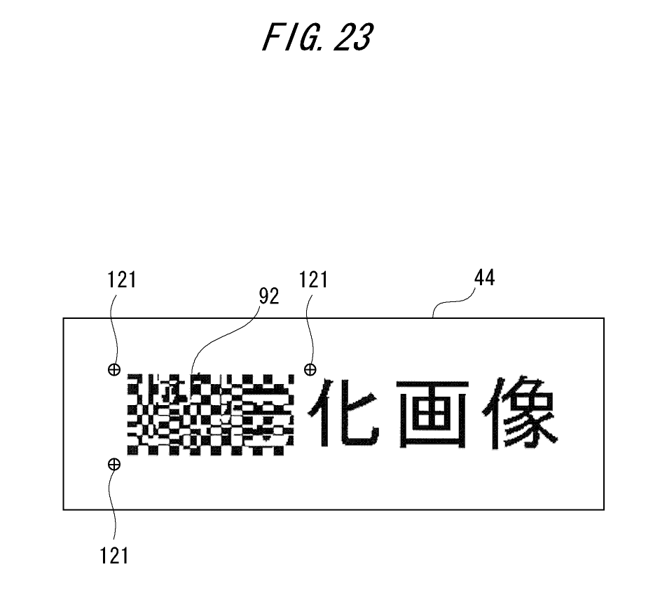

FIG. 23 is a diagram illustrating an example of the encrypted image. By the processes of the encrypting unit 11A, finally the encrypted image 44 as illustrated in FIG. 23 is generated. The encrypted image 44 contains the converted image 92 and a positioning marker 121.

Moreover, in the encrypting method according to the first mode, when the image converting unit 32 adopts the [micro area rearranging process (scramble process)], the encryption process can be applied to a gray-scale image and a color image as well as to the binary image.

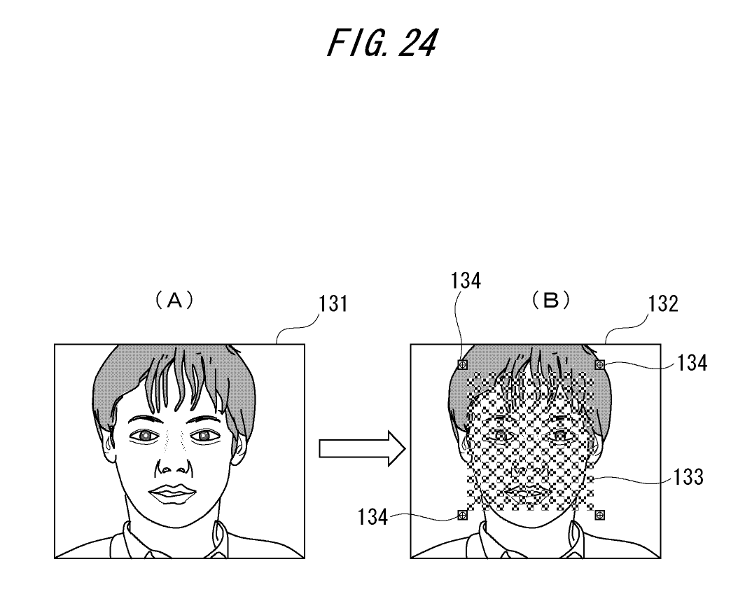

FIG. 24 shows an example of how the gray-scale image is encrypted. In FIG. 24, a gray-scale image 131 illustrated in (A) is subjected to the process by the encrypting unit 11A, thereby generating an encrypted image 132 containing a converted image 133 and a positioning marker 134 as illustrated in (B).

Next, the decrypting unit 14A will be described.

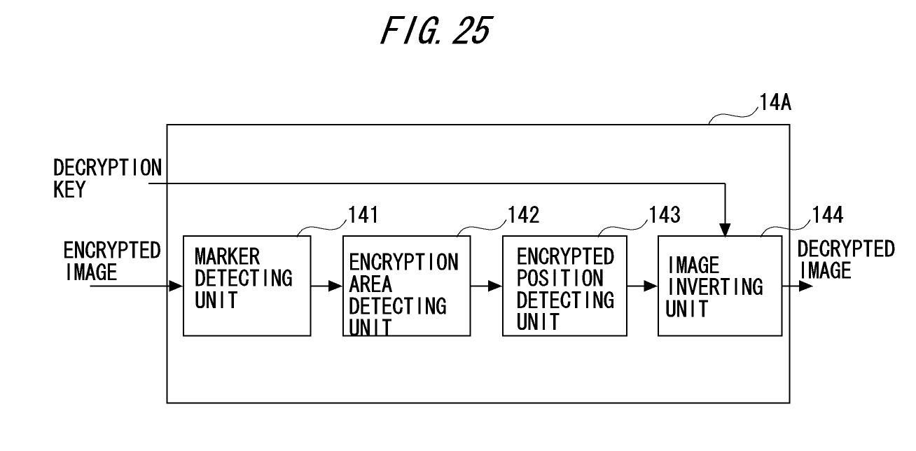

FIG. 25 is a diagram showing an outline of the decrypting process in the first mode. In FIG. 25, the decrypting unit 14A includes a marker detecting unit 141, an encryption area detecting unit 142, an encrypted position detecting unit 143 and an image inverting unit 144.

The marker detecting unit 141 detects, from the encrypted image, a position of the positioning marker added by the marker adding unit 34 in a way that uses a general image recognition technology. An applicable method as the detecting method involves using pattern matching and analyzing connectivity of graphics.

The encryption area detecting unit 142 detects the encrypted image area on the basis of the positional relation between the three positioning markers detected by the marker detecting unit 141.

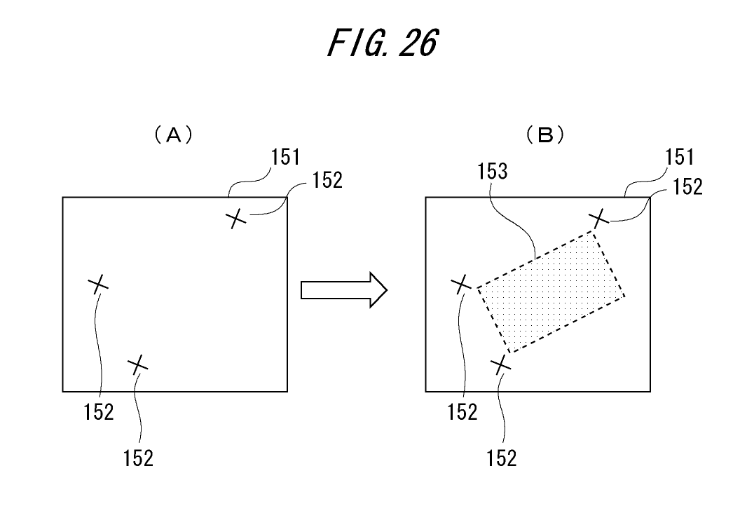

FIG. 26 is a diagram showing a process of detecting the encryption area from the positioning marker. As shown in (A) of FIG. 26, when the marker detecting unit 141 detects at least three positioning markers 152 from the encrypted image 151, as illustrated in (B), one encryption area 153 can be detected. Namely, the three positioning markers 152 are disposed at the four corners of the rectangular encryption area 153, and hence a graphic form obtained by connecting these three points (the positions of the positioning markers 152) with lines becomes roughly a right-angled triangle. Then, if the three or more positioning markers 152 are detected, the positional relation between the three positioning markers 152 embraces an area taking a shape that is approximate to the right-angled triangle, and the encryption area 153 takes a rectangular shape in which the three positioning markers 152 correspond to three angular points among the four angular points. Note that if the number of the detected positioning markers 152 is equal to or smaller than “2”, the corresponding encryption area 153 can not be specified, and hence the decrypting process is terminated on the assumption that the encrypted image does not exist.

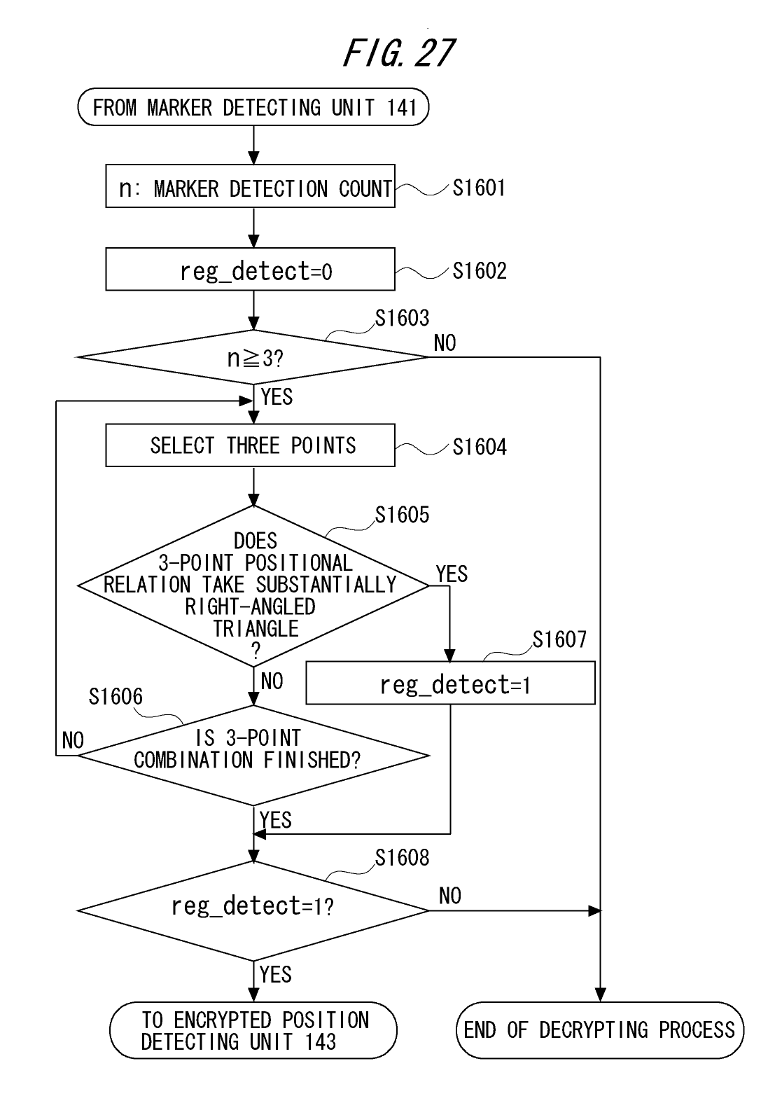

FIG. 27 is a flowchart showing a flow of the encryption area detecting process. The encryption area detecting process executed by the encryption area detecting unit 142 starts with step S1601 in which the number of the positioning markers 152 detected by the marker detecting unit 141 is substituted into a variable n, and in step S1602, “0” is substituted into a detection flag “reg_detect” of the encryption area 153.

Then, in step S1603, it is determined whether or not the variable n, into which the number of the positioning markers 152 is substituted, is equal to or larger than “3”, and, if the variable n is not equal to or larger than “3”, i.e., if the variable n is not equal to or smaller than “2” (step S1603: No), the decrypting process including the present encryption area detecting process is terminated.

While on the other hand, if the variable n is equal to or larger than “3” (step S1603: Yes), in step S1604, the three positioning markers 152 among the positioning markers 152 detected by the marker detecting unit 141 are selected, and, in step S1605, it is determined whether or not the positional relation between the thus-selected three positioning markers 152 takes substantially the right-angled triangle.

If the positional relation between the selected three positioning markers 152 does not take substantially the right-angled triangle (step S1605: No), in step S1606, it is determined whether or not a 3-point combination of the positioning markers 152 detected by the marker detecting unit 141 is completely finished, then, if not finished (step S1606: No), returning to step S1604, another set of three points is selected, and, when finished (step S1606: Yes), the operation proceeds to step S1608.

Whereas if the positional relation between the selected three positioning markers 152 takes substantially the right-angled triangle (step S1605: Yes), in step S1607, “1” is substituted into the detection flag “reg_detect”.

Then, in step S1608, it is determined whether or not “1” is substituted into the detection flag “reg_detect”, i.e., it is determined whether or not the three positioning markers 152 of which the 3-point positional relation takes the right-angled triangle can be detected, and the operation proceeds to a process by the encrypted position detecting unit 143 if “1” is substituted into the flag “reg_detect” (step S1608: Yes) and to the decrypting process including the present encryption area detecting process is finished whereas if “1” is not substituted into the flag “reg_detect” (step S1608: No).

The discussion gets back to the illustration in FIG. 25. The encrypted position detecting unit 143 detects minute positions of the respective pixels within the encryption area 153 by the frequency analysis and pattern matching in a way that makes use of a point that the edge portions of the encryption area 153 detected by the encryption area detecting unit 142 have a regular pixel distribution in order to accurately decrypt the encrypted image 151. This detection involves utilizing such a characteristic that the whole of the encrypted image 151 has the periodic pattern owing to the pixel value converting (inverting) process of the pixel value converting unit 33.

One thinkable detection method is a method of obtaining a pattern cycle (width) in horizontal and vertical directions of the image by use of a frequency analyzing method such as Fast Fourier Transform (FFT) and thereafter detecting the border positions (offset) by template matching etc.

Further, the border positions can be detected by Hough transform in a way that utilizes such a characteristic that the border portion becomes rectilinear when applying an edge detection filter (Laplacian filter etc) to the encrypted image.

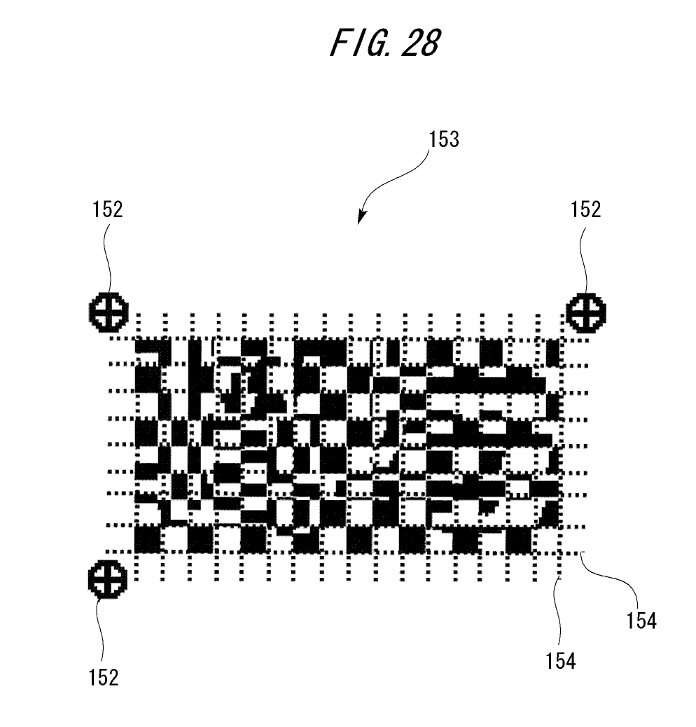

FIG. 28 is a diagram showing an example of how the encrypted positions are detected. If the encrypted digital image 41 is complicated, a possibility is that a portion with a remarkably declined cyclicality of the encrypted image 44 might appear. In this case, an effective method is a method of detecting the encrypted positions in a way that limits the image area used for calculating the pattern cycle and the border positions to the portions exhibiting comparatively strong cyclicality.

The discussion gets back to the illustration in FIG. 25. The image inverting unit 144 executes, about the encrypted image 44, the inverting process of the converting process of the image inverting unit 32 on the basis of a method corresponding to a decryption key by use of the encrypted position information detected by the encrypted position detecting unit 143 and the decryption key inputted by a user, thereby generating a decrypted image. A procedure of the decrypting process is realized by the procedure reversed to the encrypting process, and hence its description is omitted. What has been discussed so far is the description of the first mode to which the present invention is applied.

Next, a second mode to which the present invention is applied will be described.

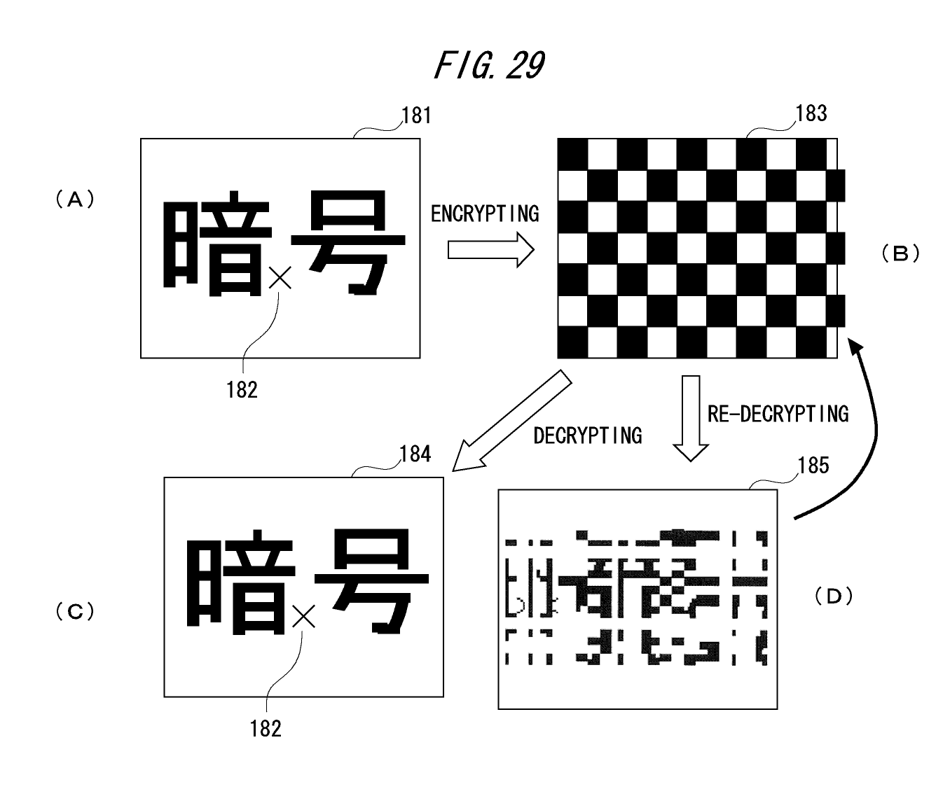

FIG. 29 is a diagram showing a whole image according to the second mode. The second mode is that before the encrypting process, a specified check mark 182 for verifying validity of decrypting the encrypted image 183 ((A) in FIG. 29) is attached to an arbitrary position of an area 181 to be encrypted, then the encryption is conducted ((B) in FIG. 29), the decryption is considered to be performed correctly if the check mark 182 attached beforehand is detected from the decrypted image 184 after decrypting the encrypted image 183, and the decrypting process is terminated ((C) in FIG. 29). Whereas if the check mark 182 is not detected ((D) in FIG. 29), the encrypted position is corrected, and the decrypting process is repeated till the check mark 182 is detected or till a designated standard is satisfied.

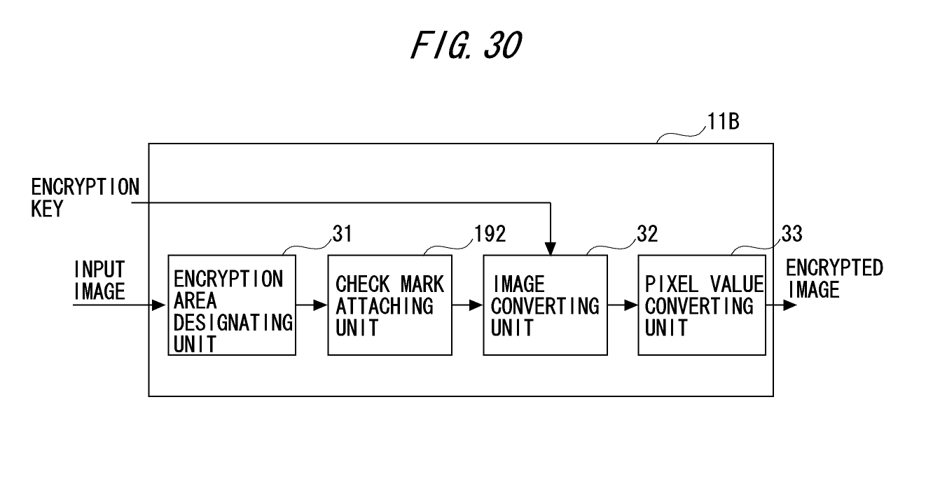

FIG. 30 is a diagram illustrating an outline of the encrypting process in the second mode. In FIG. 30, the encrypting unit 11B includes the encryption area determining unit 31, a check mark attaching unit 192, the image converting unit 32 and the pixel value converting unit 33.

In the same way as in the first mode, the encryption area designating unit 31 selects the to-be-encryption area from the input image containing a want-to-encrypt area.

Then, the check mark attaching unit 192 attaches the specified check mark 182 for verifying the validity of decrypting the encrypted image 183 to the arbitrary position of the area 181 to the encrypted. The check mark 182 is, it is desirable, attached to an area having, if possible, fewer image information and a flat pixel distribution.

After attaching the check mark 182 to the designated position, in the same way as in the first mode, the image converting unit 32 inputs the area 181 to be encrypted and the encryption key, an image of the area 181 to be encrypted is visually converted by the converting method corresponding to the encryption key, and the pixel value converting unit 33 converts at the fixed intervals the pixels within the processed image converted by the image converting unit 32, thus making the converted image take substantially the grating-shaped stripped pattern.

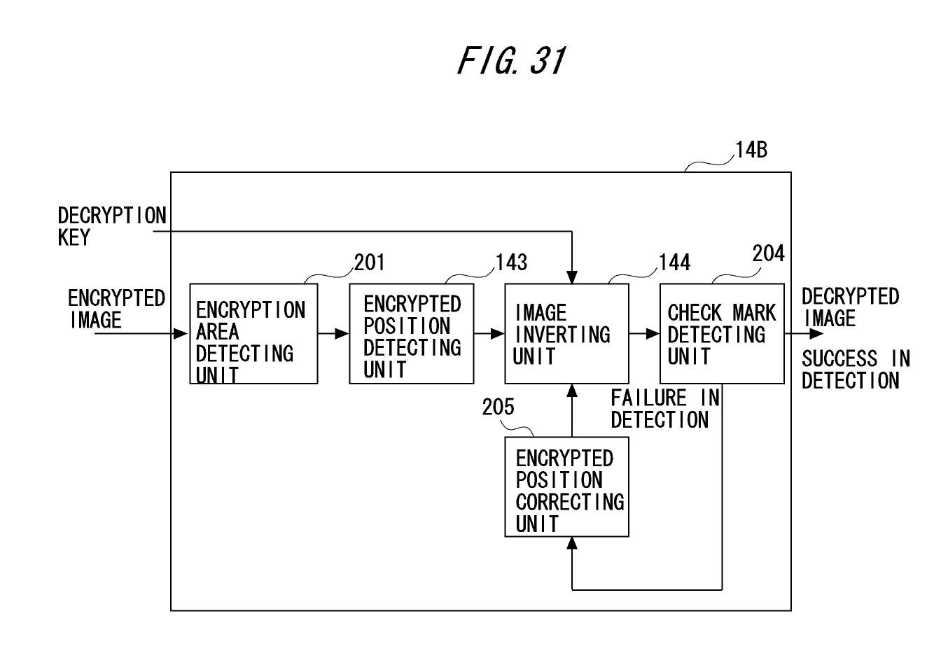

FIG. 31 is a diagram showing an outline of the decrypting process in the second mode. In FIG. 31, the decrypting unit 14B includes an encryption area detecting unit 201, an encrypted position detecting unit 143, an image inverting unit 144, a check mark detecting unit 204 and an encrypted position correcting unit 205.

To start with, the encryption area detecting unit 201 detects a rough area of the encrypted image 183. Through the encrypting process by the encrypting unit 11B, a pixel distribution of the encrypted image 183 takes roughly a checkered pattern, and therefore, if the frequency analysis such as FFT is conducted about the horizontal and vertical directions thereof, power of a frequency corresponding to a stripe cycle becomes conspicuously strong.

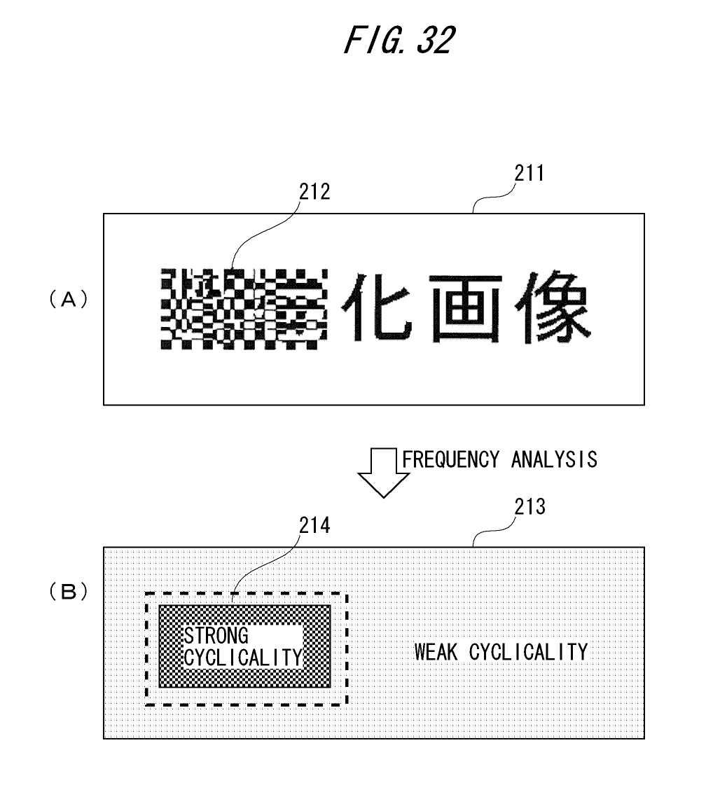

FIG. 32 is an explanatory diagram of a method of detecting the encryption area. As illustrated in (A) of FIG. 32, when performing the frequency analysis about an encrypted image 211, as shown in (B), a power intensive area of a certain frequency is expressed as a [strong cyclicality] 214 (a frequency of an integral multiple of the former frequency). The cyclicality of the pixel distribution within the encryption area tends to be strong, and it is therefore feasible to detect a rough encryption area and a stripped pattern cycle.

The discussion gets back to the illustration in FIG. 31. The encrypted position detecting unit 143, after the encryption area detecting unit 201 has specified a rough encryption area, detects the encryption area more precisely, and simultaneously the minute positions of the respective pixels in the encryption area. Such a method can be considered as one example of the positional detection that the border position (offset) of the pixel-value conversion is obtained from the stripped pattern cycle acquired by the encryption area detecting unit 201 and from an absolute pixel value difference distribution, and the areas exhibiting a comparatively large absolute pixel value difference are further narrowed down therefrom. Moreover, in the same way as by the encrypted position detecting unit 143 in the first mode, the detection of the encrypted position can involve using the Hough transform.

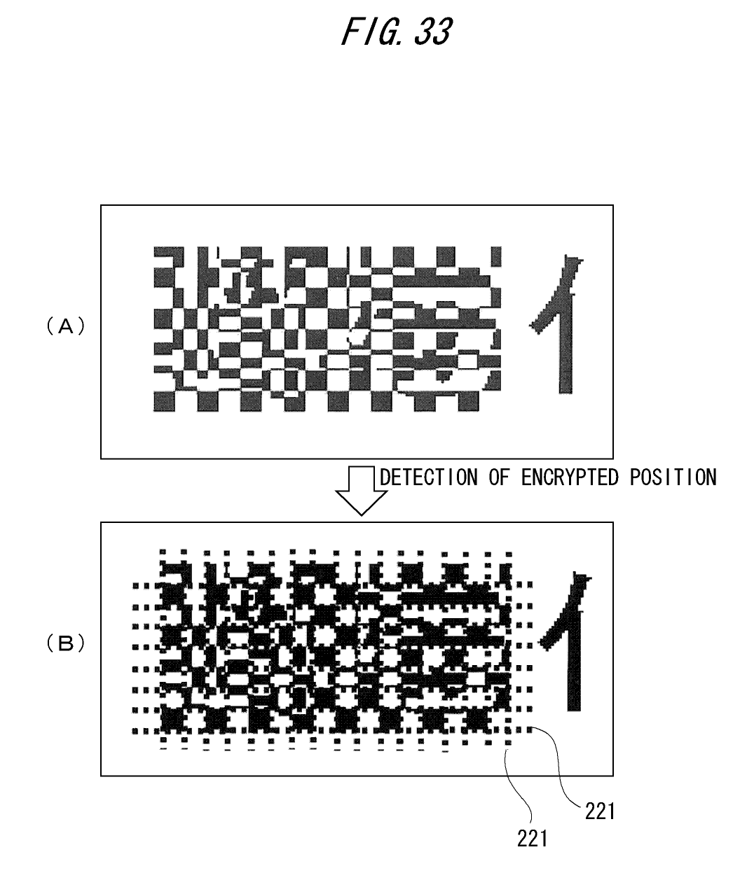

FIG. 33 is an explanatory diagram of the method of detecting the encrypted position (in the horizontal direction). As stated above, when the encryption area detecting process described above is conducted respectively in the horizontal direction and in the vertical direction, as illustrated in FIG. 33, an encrypted position 221 is detected.

The discussion gets back to the illustration in FIG. 31. The image inverting unit 144 generates a decrypted image by executing the same method as in the first mode in a way that employs the information on the encrypted position and a decryption key.

The check mark detecting unit 204 tries to detect the check mark from the decrypted image decrypted by the image inverting unit 144. The detecting method is the same as the marker detecting process in the first mode, and hence its explanation is omitted. Then, when the check mark is detected, the decrypted image is output, and the process is terminated. When the check mark is not detected, the encrypted position correcting unit 205 corrects the encrypted position, and, till the check mark is detected or till a designated standard is satisfied, the decrypting process (image inverting process) is redone.

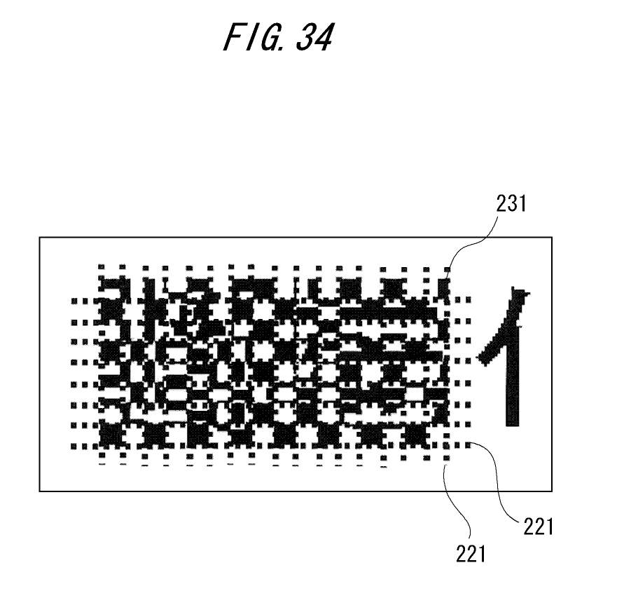

FIG. 34 is a diagram showing an example of how the encrypted position is mis-detected. As illustrated in FIG. 34, there is considered a case in which an edge of the encrypted image is overlooked (a fail-in-detection line 231). Such being the case, when failing to detect the check mark 221, lines representing the encrypted position are added to or deleted from the left right edge and the upper lower edge, and the image inverting process is executed, thus examining in various ways whether the check mark 221 is detected or not. If the check mark 221 can not be detected by adding or deleting the lines in whatever manner, the process is ended without outputting the decrypted image. What has been discussed so far is the description about the second mode to which the present invention is applied.

Next, a third mode to which the present invention is applied will be described. The third mode of the present invention entails encrypting the image and decrypting the encrypted image by use of both of the positioning marker for specifying the encryption area that is exemplified in the first mode and the check mark for determining the validity of the decrypted image in the second mode. An image decryption error caused when the valid decryption key is inputted can be reduced by use of the two types of markers such as the position marker for the positional detection and the check mark for checking the decrypted image.

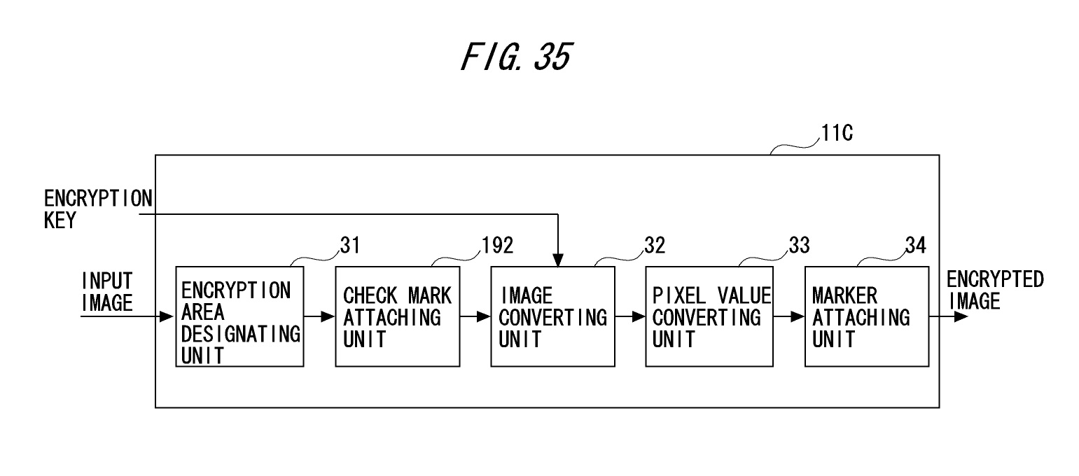

FIG. 35 is a diagram showing an outline of the encrypting process in the third mode. In FIG. 35, the encrypting unit 11C includes the encryption area determining unit 31, a check mark attaching unit 192, the image converting unit 32, the pixel value converting unit 33 and the marker attaching unit 34.

To begin with, the encryption area determining unit 31 selects the image area to be encrypted, and the check mark attaching unit 192 attaches the check mark for verifying the decryption by the same method as in the second mode. After attaching the check mark, the image converting unit 32 and the pixel value converting unit 33 encrypt the image by executing the image process by the same method as in the first and second modes, and the marker attaching unit 34 attaches the positioning marker for detecting the encryption area by the same method as in the first mode. The contents of the respective processes are the same as those in the first or second mode, and hence their explanations are omitted.

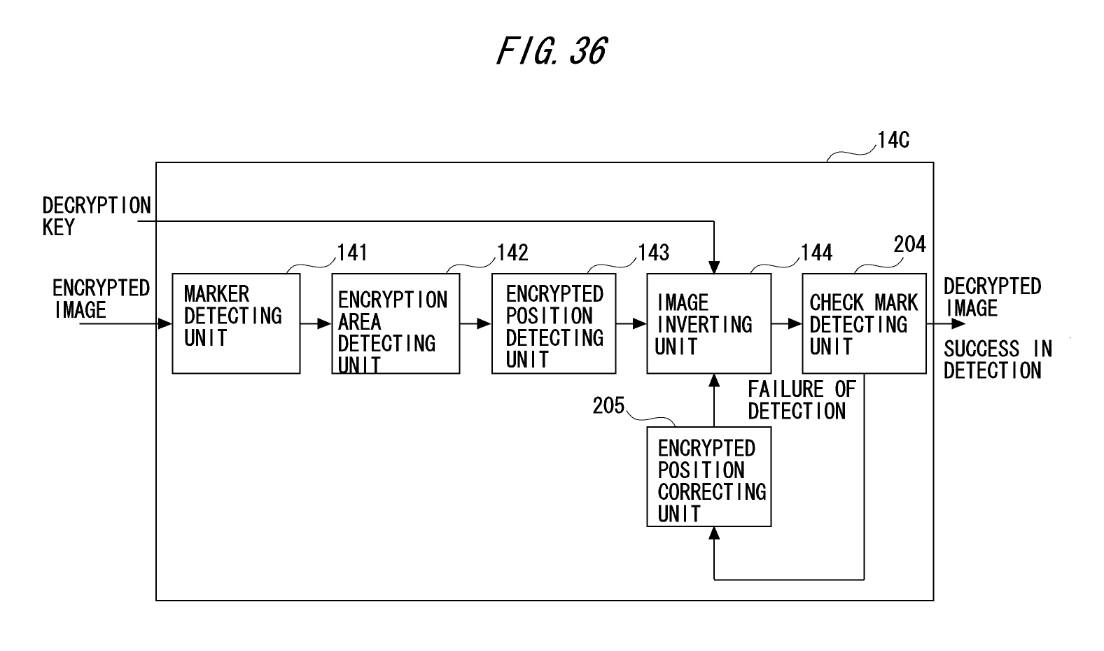

FIG. 36 is a diagram showing an outline of the decrypting process in the third mode. In FIG. 36, the decrypting unit 14C includes the marker detecting unit 141, the encryption area detecting unit 142, the encrypted position detecting unit 143, the image inverting unit 144, the check mark detecting unit 204 and the encrypted position correcting unit 205.

At first, the marker detecting unit 141 detects the positioning marker by the same method as in the first mode, and subsequently the encryption area detecting unit 142 detects the encryption area by the same method as in the first mode. Moreover, the encrypted position detecting unit 143 detects the minute positions of the respective pixels in the encryption area by the same method as in the first mode. Furthermore, the respective processing procedures executed by the check mark detecting unit 204 and the encrypted position correcting unit 205 are the same as those in the second mode, and hence their explanations are omitted. What has been discussed so far is the description about the third mode to which the present invention is applied.

What is claimed is:

1. An image processing system decrypting an encrypted image generated by converting at least a partial area of a digital image defined as an aggregation of pixels in a way that uses an encryption key, comprising:
a decryption key storage unit stored with a decryption key associated with the encryption key in the way of being associated with a user assigned authority for decrypting the conversion area as the area converted by use of the encryption key and for browsing the decrypted area;
a user authenticating unit authenticating the user;
an encrypted image acquiring unit acquiring the decrypting target encrypted image;
a decryption key acquiring unit acquiring the decryption key associated with the authenticated user authenticated by said user authenticating unit from within the decryption keys stored in said decryption key storage unit; and
a decrypting unit decrypting the conversion area in the encrypted image by use of the decryption key acquired by said decryption key acquiring unit to thereby generate the digital image containing the decrypted conversion area about which the authenticated user has the decrypting and browsing authority in the conversion areas.

2. An image processing system according to claim 1, wherein said encrypted image acquiring unit acquires the encrypted image containing the plurality of conversion area converted by use of encryption keys different from each other,
said decryption key acquiring unit acquires the decryption key associated with the authenticated user, and
said decrypting unit decrypts the conversion area about which the authenticated user has the decrypting and browsing authority in the plurality of conversion areas contained in the encrypted image by use of the decryption key acquired by said decryption key acquiring unit.

3. An image processing system according to claim 2, wherein the authority assigned to the user has a hierarchical relationship, and
said decryption key acquiring unit acquires the decryption key associated with the authenticated user and the decryption key associated with the user assigned the lower-level of authority than that of the authenticated user in the decryption keys stored ins aid decryption key storage unit.

4. An image processing system according to claim 1, further comprising:
an area designating information acquiring unit acquiring area designating information for specifying the conversion area contained in the encrypted image acquired by said encrypted image acquiring unit,
wherein said decrypting unit decrypts the conversion area specified by the area designating information acquired by said area designating information acquiring unit by use of the decryption key acquired by said decryption key acquiring unit.

5. An image processing system according to claim 4, wherein said area designating information acquiring unit acquires the area designating information from information added to the encrypted image.

6. An image processing system according to claim 4, further comprising:
an area designating information accumulating unit accumulated with the area designating information in the way of being associated with the encrypted image,
wherein said area designating information acquiring unit acquires the area designating information associated with the encrypted image acquired by said encrypted image acquiring unit from the area designating information accumulated in said area designating information accumulating unit.

7. An image processing system according to claim 4, wherein the area designating information contains information on a conversion sequence when in encryption if the encrypted image contains a plurality of conversion areas of which at least some areas are overlapped, and
said decrypting unit decrypts the conversion areas in a sequence based on the conversion sequence contained in the area designating information acquired by said area designating information acquiring unit.

8. An image processing system generating an encrypted image based on a digital image defined as an aggregation of pixels, comprising:
an encryption key storage unit stored with an encryption key associated with a decryption key used for decrypting the encrypted image in the way of being associated with a user assigned authority for decrypting a conversion area as an area converted by using the encryption key in the digital image and browsing the decrypted area;
an authorized user designation accepting unit accepting an input of designation of an authorized user authorized to decrypt the conversion area and browse the decrypted area;
a digital image acquiring unit acquiring the encrypting target digital image;
an encryption key acquiring unit acquiring an encryption key associated with the authorized user accepted by said authorized user designation accepting unit in the encryption keys stored in said encryption key storage unit; and
an encrypting unit converting at least a partial area in the digital image by use of the encryption key acquired by said encryption key acquiring unit to thereby generate the encrypted image containing the conversion area that can be decrypted by employing the decryption key associated with the encryption key.

9. An image processing system according to claim 8, wherein said authorized user designation accepting unit accepts an input of designation of a plurality of authorized users,
said encryption key acquiring unit acquires the encryption key different on a per-plural-users basis, and
said encrypting unit converts the plurality of areas in the digital image by use of the encryption keys different from each other, thereby generating the encrypted image containing the plurality of conversion areas.

10. An image processing system according to claim 8, further comprising an area designating information adding unit adding the area designating information for specifying the conversion area converted by said encrypting unit to the encrypted image.

11. An image processing system according to claim 8, further comprising an area designating information accumulating unit accumulated with the area designating information for specifying the conversion area converted by said encrypting unit in the way of being associated with the generated encrypted image.

12. An image processing system according to claim 10, wherein said encrypting unit, if at least some of the plurality of converting target areas are overlapped, converts the areas in a predetermined sequence, and
the area designating information contains information on the conversion sequence of said encrypting unit.

13. An image processing system according to claim 8, further comprising an electronic data accepting unit accepting an input of electronic data,
wherein said digital image acquiring unit acquires the digital image by generating the digital image as the aggregation of pixels on the basis of the electronic data.

14. A readable-by-computer recording medium recorded with an image processing program for decrypting an encrypted image generated by converting at least a partial area of a digital image defined as an aggregation of pixels in a way that uses an encryption key, said program making a computer function as:
a decryption key storage unit stored with a decryption key associated with the encryption key in the way of being associated with a user assigned authority for decrypting the conversion area as the area converted by use of the encryption key and for browsing the decrypted area;
a user authenticating unit authenticating the user;
an encrypted image acquiring unit acquiring the decrypting target encrypted image;
a decryption key acquiring unit acquiring the decryption key associated with the authenticated user authenticated by said user authenticating unit from within the decryption keys stored in said decryption key storage unit; and
a decrypting unit decrypting the conversion area in the encrypted image by use of the decryption key acquired by said decryption key acquiring unit to thereby generate the digital image containing the decrypted conversion area about which the authenticated user has the decrypting and browsing authority in the conversion areas.

15. A readable-by-computer recording medium recorded with an image processing program for generating an encrypted image based on a digital image defined as an aggregation of pixels, said program making a computer function as:
an encryption key storage unit stored with an encryption key associated with a decryption key used for decrypting the encrypted image in the way of being associated with a user assigned authority for decrypting a conversion area as an area converted by using the encryption key in the digital image and browsing the decrypted area;
an authorized user designation accepting unit accepting an input of designation of an authorized user authorized to decrypt the conversion area and browse the decrypted area;
a digital image acquiring unit acquiring the encrypting target digital image;
an encryption key acquiring unit acquiring an encryption key associated with the authorized user accepted by said authorized user designation accepting unit in the encryption keys stored in said encryption key storage unit; and
an encrypting unit converting at least a partial area in the digital image by use of the encryption key acquired by said encryption key acquiring unit to thereby generate the encrypted image containing the conversion area that can be decrypted by employing the decryption key associated with the encryption key.
